(19) United States
(12) Patent Application Publication
(10) Pub. No.: US 2026/0088518 A1
(43) Pub. Date: Mar. 26, 2026

(54) APPARATUS, SYSTEM, AND METHOD OF CONTROLLING AN ARRAY-RADIATION PATTERN OF AN ANTENNA ARRAY

(71) Applicant: MobilEye Vision Technologies Ltd., Jerusalem (IL)

(72) Inventors: Omer Asaf, Oranit (IL); Naftali Landsberg, Kiryat Ono (IL); Danniel Nahmanny, Maor (IL); Meir Gordon, Holon (IL); Ophir Shabtay, Tsofit (IL)

(73) Assignee: MobilEye Vision Technologies Ltd., Jerusalem (IL)

(21) Appl. No.: 19/287,359

(22) Filed: Jul. 31, 2025

Related U.S. Application Data
(60) Provisional application No. 63/697,546, filed on Sep. 22, 2024.

(51) Int. Cl. H01Q 21/06; H01Q 1/32; H01Q 21/29

(52) U.S. Cl. CPC H01Q 21/065; H01Q 21/29; H01Q 1/32

(57) ABSTRACT

For example, an apparatus may include an antenna array, which may be configured to include a plurality of configurable-radiation-pattern antenna elements. For example, a configurable-radiation-pattern antenna element of the plurality of configurable-radiation-pattern antenna elements may have a configurable element-radiation-pattern. For example, the apparatus may include control circuitry, which may be configured to control an array-radiation-pattern of the antenna array. For example, the control circuitry may be configured to control the array-radiation-pattern of the antenna array according to an array-radiation-pattern setting, for example, by configuring a plurality of element-radiation-patterns for the plurality of configurable-radiation-pattern antenna elements based on the array-radiation-pattern setting.

### CROSS-REFERENCE

This application claims the benefit of and priority from U.S. Provisional Patent Application No. 63/697,546, entitled “APPARATUS, SYSTEM, AND METHOD OF CONTROLLING AN ARRAY-RADIATION PATTERN OF AN ANTENNA ARRAY”, filed Sep. 22, 2024, the entire disclosure of which is incorporated herein by reference.

### BACKGROUND

An antenna array may be implemented by various types of devices, for example, for wireless communication and/or other suitable applications.

The antenna array typically includes an array of antenna elements.

A radiation pattern of the antenna array may define a directional and/or an angular dependence of a strength of radio waves communicated by the antenna array.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a vehicle implementing a radar, in accordance with some demonstrative aspects.

FIG. 2 is a schematic block diagram illustration of a robot implementing a radar, in accordance with some demonstrative aspects.

FIG. 3 is a schematic block diagram illustration of a radar apparatus, in accordance with some demonstrative aspects.

FIG. 4 is a schematic block diagram illustration of a Frequency-Modulated Continuous Wave (FMCW) radar apparatus, in accordance with some demonstrative aspects.

FIG. 5 is a schematic illustration of an extraction scheme, which may be implemented to extract range and speed (Doppler) estimations from digital reception radar data values, in accordance with some demonstrative aspects.

FIG. 6 is a schematic illustration of an angle-determination scheme, which may be implemented to determine Angle of Arrival (AoA) information based on an incoming radio signal received by a receive antenna array, in accordance with some demonstrative aspects.

FIG. 7 is a schematic illustration of a Multiple-Input-Multiple-Output (MIMO) radar antenna scheme, which may be implemented based on a combination of Transmit (Tx) and Receive (Rx) antennas, in accordance with some demonstrative aspects.

FIG. 8 is a schematic block diagram illustration of elements of a radar device including a radar frontend and a radar processor, in accordance with some demonstrative aspects.

FIG. 9 is a schematic illustration of a radar system including a plurality of radar devices implemented in a vehicle, in accordance with some demonstrative aspects.

FIG. 10 is a schematic illustration of a system, in accordance with some demonstrative aspects.

FIG. 11 is a schematic illustration of a multi-patch antenna element, in accordance with some demonstrative aspects.

FIG. 12 is a schematic illustration of a dual-patch antenna element, in accordance with some demonstrative aspects.

FIG. 13 is a schematic illustration of radiation patterns of a dual-patch antenna element, in accordance with some demonstrative aspects.

FIG. 14 is a schematic illustration of radiation pattern adaptation scenarios, in accordance with some demonstrative aspects.

FIG. 15 is a schematic illustration of Rx circuitry including Rx control circuitry, in accordance with some demonstrative aspects.

FIG. 16 is a schematic illustration of Rx circuitry including Rx control circuitry, in accordance with some demonstrative aspects.

FIG. 17 is a schematic illustration of Tx circuitry including Tx control circuitry, in accordance with some demonstrative aspects.

FIG. 18 is a schematic illustration of Tx circuitry including Tx control circuitry, in accordance with some demonstrative aspects.

FIG. 19 is a schematic flow chart illustration of a method of controlling an array-radiation-pattern of an antenna array, in accordance with some demonstrative aspects.

FIG. 20 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

The words “exemplary” and “demonstrative” are used herein to mean “serving as an example, instance, demonstration, or illustration”. Any aspect, or design described herein as “exemplary” or “demonstrative” is not necessarily to be construed as preferred or advantageous over other aspects, or designs.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

The phrases “at least one” and “one or more” may be understood to include a numerical quantity greater than or equal to one, e.g., one, two, three, four, [ . . . ], etc. The phrase “at least one of” with regard to a group of elements may be used herein to mean at least one element from the group consisting of the elements. For example, the phrase “at least one of” with regard to a group of elements may be used herein to mean one of the listed elements, a plurality of one of the listed elements, a plurality of individual listed elements, or a plurality of a multiple of individual listed elements.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and/or may represent any information as understood in the art.

The terms “processor” or “controller” may be understood to include any kind of technological entity that allows handling of any suitable type of data and/or information. The data and/or information may be handled according to one or more specific functions executed by the processor or controller. Further, a processor or a controller may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), and the like, or any combination thereof. Any other kind of implementation of the respective functions, which will be described below in further detail, may also be understood as a processor, controller, or logic circuit. It is understood that any two (or more) processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “memory” is understood as a computer-readable medium (e.g., a non-transitory computer-readable medium) in which data or information can be stored for retrieval. References to “memory” may thus be understood as referring to volatile or non-volatile memory, including random access memory (RAM), read-only memory (ROM), flash memory, solid-state storage, magnetic tape, hard disk drive, optical drive, among others, or any combination thereof. Registers, shift registers, processor registers, data buffers, among others, are also embraced herein by the term memory. The term “software” may be used to refer to any type of executable instruction and/or logic, including firmware.

A “vehicle” may be understood to include any type of driven object. By way of example, a vehicle may be a driven object with a combustion engine, an electric engine, a reaction engine, an electrically driven object, a hybrid driven object, or a combination thereof. A vehicle may be, or may include, an automobile, a bus, a mini bus, a van, a truck, a mobile home, a vehicle trailer, a motorcycle, a bicycle, a tricycle, a train locomotive, a train wagon, a moving robot, a personal transporter, a boat, a ship, a submersible, a submarine, a drone, an aircraft, a rocket, among others.

A “ground vehicle” may be understood to include any type of vehicle, which is configured to traverse the ground, e.g., on a street, on a road, on a track, on one or more rails, off-road, or the like.

An “autonomous vehicle” may describe a vehicle capable of implementing at least one navigational change without driver input. A navigational change may describe or include a change in one or more of steering, braking, acceleration/deceleration, or any other operation relating to movement, of the vehicle. A vehicle may be described as autonomous even in case the vehicle is not fully autonomous, for example, fully operational with driver or without driver input. Autonomous vehicles may include those vehicles that can operate under driver control during certain time periods, and without driver control during other time periods. Additionally or alternatively, autonomous vehicles may include vehicles that control only some aspects of vehicle navigation, such as steering, e.g., to maintain a vehicle course between vehicle lane constraints, or some steering operations under certain circumstances, e.g., not under all circumstances, but may leave other aspects of vehicle navigation to the driver, e.g., braking or braking under certain circumstances. Additionally or alternatively, autonomous vehicles may include vehicles that share the control of one or more aspects of vehicle navigation under certain circumstances, e.g., hands-on, such as responsive to a driver input; and/or vehicles that control one or more aspects of vehicle navigation under certain circumstances, e.g., hands-off, such as independent of driver input. Additionally or alternatively, autonomous vehicles may include vehicles that control one or more aspects of vehicle navigation under certain circumstances, such as under certain environmental conditions, e.g., spatial areas, roadway conditions, or the like. In some aspects, autonomous vehicles may handle some or all aspects of braking, speed control, velocity control, steering, and/or any other additional operations, of the vehicle. An autonomous vehicle may include those vehicles that can operate without a driver. The level of autonomy of a vehicle may be described or determined by the Society of Automotive Engineers (SAE) level of the vehicle, e.g., as defined by the SAE, for example in SAE J3016 2018: Taxonomy and definitions for terms related to driving automation systems for on road motor vehicles, or by other relevant professional organizations. The SAE level may have a value ranging from a minimum level, e.g., level 0 (illustratively, substantially no driving automation), to a maximum level, e.g., level 5 (illustratively, full driving automation).

An “assisted vehicle” may describe a vehicle capable of informing a driver or occupant of the vehicle of sensed data or information derived therefrom.

The phrase “vehicle operation data” may be understood to describe any type of feature related to the operation of a vehicle. By way of example, “vehicle operation data” may describe the status of the vehicle, such as, the type of tires of the vehicle, the type of vehicle, and/or the age of the manufacturing of the vehicle. More generally, “vehicle operation data” may describe or include static features or static vehicle operation data (illustratively, features or data not changing over time). As another example, additionally or alternatively, “vehicle operation data” may describe or include features changing during the operation of the vehicle, for example, environmental conditions, such as weather conditions or road conditions during the operation of the vehicle, fuel levels, fluid levels, operational parameters of the driving source of the vehicle, or the like. More generally, “vehicle operation data” may describe or include varying features or varying vehicle operation data (illustratively, time varying features or data).

Some aspects may be used in conjunction with various devices and systems, for example, a radar sensor, a radar device, a radar system, a vehicle, a vehicular system, an autonomous vehicular system, a vehicular communication system, a vehicular device, an airborne platform, a waterborne platform, road infrastructure, sports-capture infrastructure, city monitoring infrastructure, static infrastructure platforms, indoor platforms, moving platforms, robot platforms, industrial platforms, a sensor device, a User Equipment (UE), a Mobile Device (MD), a wireless station (STA), a sensor device, a non-vehicular device, a mobile or portable device, and the like.

Some aspects may be used in conjunction with Radio Frequency (RF) systems, radar systems, vehicular radar systems, autonomous systems, robotic systems, detection systems, or the like.

Some demonstrative aspects may be used in conjunction with an RF frequency in a frequency band having a starting frequency above 10 Gigahertz (GHz), for example, a frequency band having a starting frequency between 10 GHz and 120 GHz. For example, some demonstrative aspects may be used in conjunction with an RF frequency having a starting frequency above 30 GHz, for example, above 45 GHz, e.g., above 60 GHz. For example, some demonstrative aspects may be used in conjunction with an automotive radar frequency band, e.g., a frequency band between 76 GHz and 81 GHz. However, other aspects may be implemented utilizing any other suitable frequency bands, for example, a frequency band above 140 GHz, a frequency band of 300 GHz, a sub Terahertz (THz) band, a THz band, an Infra-Red (IR) band, and/or any other frequency band.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality In some aspects, some functions associated with the circuitry may be implemented by one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g., radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and/or the like. Logic may be executed by one or more processors using memory, e.g., registers, buffers, stacks, and the like, coupled to the one or more processors, e.g., as necessary to execute the logic.

The term “communicating” as used herein with respect to a signal includes transmitting the signal and/or receiving the signal. For example, an apparatus, which is capable of communicating a signal, may include a transmitter to transmit the signal, and/or a receiver to receive the signal. The verb communicating may be used to refer to the action of transmitting or the action of receiving. In one example, the phrase “communicating a signal” may refer to the action of transmitting the signal by a transmitter, and may not necessarily include the action of receiving the signal by a receiver. In another example, the phrase “communicating a signal” may refer to the action of receiving the signal by a receiver, and may not necessarily include the action of transmitting the signal by a transmitter.

The term “antenna”, as used herein, may include any suitable configuration, structure, and/or arrangement of one or more antenna elements, components, units, assemblies, and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a MIMO (Multiple-Input Multiple-Output) array antenna, a single element antenna, a set of switched beam antennas, and/or the like. In one example, an antenna may be implemented as a separate element or an integrated element, for example, as an on-module antenna, an on-chip antenna, or according to any other antenna architecture.

Some demonstrative aspects are described herein with respect to RF radar signals. However, other aspects may be implemented with respect to, or in conjunction with, any other radar signals, wireless signals, IR signals, acoustic signals, optical signals, wireless communication signals, communication scheme, network, standard, and/or protocol. For example, some demonstrative aspects may be implemented with respect to systems, e.g., Light Detection Ranging (LiDAR) systems, and/or sonar systems, utilizing light and/or acoustic signals.

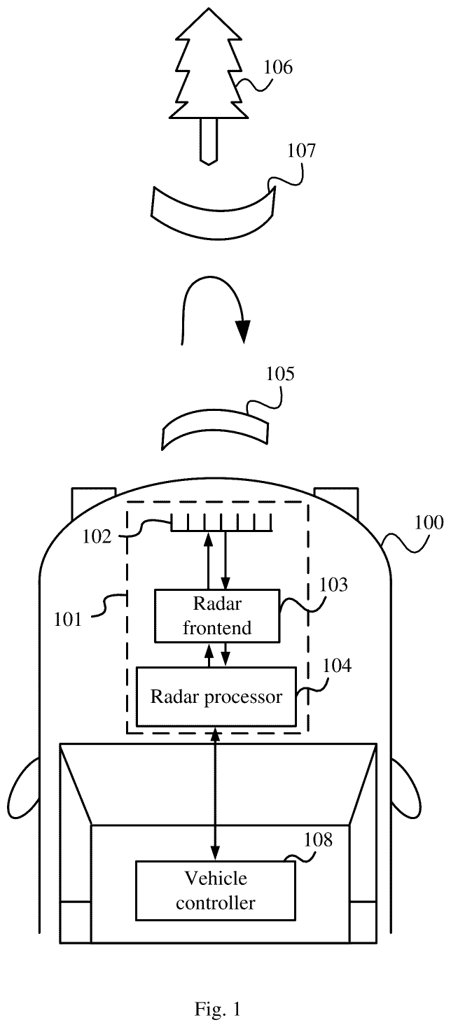

Reference is now made to FIG. 1, which schematically illustrates a block diagram of a vehicle 100 implementing a radar, in accordance with some demonstrative aspects.

In some demonstrative aspects, vehicle 100 may include a car, a truck, a motorcycle, a bus, a train, an airborne vehicle, a waterborne vehicle, a cart, a golf cart, an electric cart, a road agent, or any other vehicle.

In some demonstrative aspects, vehicle 100 may include a radar device 101, e.g., as described below. For example, radar device 101 may include a radar detecting device, a radar sensing device, a radar sensor, or the like, e.g., as described below.

In some demonstrative aspects, radar device 101 may be implemented as part of a vehicular system, for example, a system to be implemented and/or mounted in vehicle 100.

In one example, radar device 101 may be implemented as part of an autonomous vehicle system, an automated driving system, an assisted vehicle system, a driver assistance and/or support system, and/or the like.

For example, radar device 101 may be installed in vehicle 100 for detection of nearby objects, e.g., for autonomous driving.

In some demonstrative aspects, radar device 101 may be configured to detect targets in a vicinity of vehicle 100, e.g., in a far vicinity and/or a near vicinity, for example, using RF and analog chains, capacitor structures, large spiral transformers and/or any other electronic or electrical elements, e.g., as described below.

In one example, radar device 101 may be mounted onto, placed, e.g., directly, onto, or attached to, vehicle 100.

In some demonstrative aspects, vehicle 100 may include a plurality of radar aspects, vehicle 100 may include a single radar device 101.

In some demonstrative aspects, vehicle 100 may include a plurality of radar devices 101, which may be configured to cover a field of view of 360 degrees around vehicle 100.

In other aspects, vehicle 100 may include any other suitable count, arrangement, and/or configuration of radar devices and/or units, which may be suitable to cover any other field of view, e.g., a field of view of less than 360 degrees.

In some demonstrative aspects, radar device 101 may be implemented as a component in a suite of sensors used for driver assistance and/or autonomous vehicles, for example, due to the ability of radar to operate in nearly all-weather conditions.

In some demonstrative aspects, radar device 101 may be configured to support autonomous vehicle usage, e.g., as described below.

In one example, radar device 101 may determine a class, a location, an orientation, a velocity, an intention, a perceptional understanding of the environment, and/or any other information corresponding to an object in the environment.

In another example, radar device 101 may be configured to determine one or more parameters and/or information for one or more operations and/or tasks, e.g., path planning, and/or any other tasks.

In some demonstrative aspects, radar device 101 may be configured to map a scene by measuring targets' echoes (reflectivity) and discriminating them, for example, mainly in range, velocity, azimuth and/or elevation, e.g., as described below.

In some demonstrative aspects, radar device 101 may be configured to detect, and/or sense, one or more objects, which are located in a vicinity, e.g., a far vicinity and/or a near vicinity, of the vehicle 100, and to provide one or more parameters, attributes, and/or information with respect to the objects.

In some demonstrative aspects, the objects may include road users, such as other vehicles, pedestrians; road objects and markings, such as traffic signs, traffic lights, lane markings, road markings, road elements, e.g., a pavement-road meeting, a road edge, a road profile, road roughness (or smoothness); general objects, such as a hazard, e.g., a tire, a box, a crack in the road surface; and/or the like.

In some demonstrative aspects, the one or more parameters, attributes and/or information with respect to the object may include a range of the objects from the vehicle 100, an angle of the object with respect to the vehicle 100, a location of the object with respect to the vehicle 100, a relative speed of the object with respect to vehicle 100, and/or the like.

In some demonstrative aspects, radar device 101 may include a Multiple Input Multiple Output (MIMO) radar device 101, e.g., as described below.

In one example, the MIMO radar device may be configured to utilize “spatial filtering” processing, for example, beamforming and/or any other mechanism, for one or both of Transmit (Tx) signals and/or Receive (Rx) signals.

Some demonstrative aspects are described below with respect to a radar device, e.g., radar device 101, implemented as a MIMO radar. However, in other aspects, radar device 101 may be implemented as any other type of radar utilizing a plurality of antenna elements, e.g., a Single Input Multiple Output (SIMO) radar or a Multiple Input Single output (MISO) radar.

Some demonstrative aspects may be implemented with respect to a radar device, e.g., radar device 101, implemented as a MIMO radar, e.g., as described below. However, in other aspects, radar device 101 may be implemented as any other type of radar, for example, an Electronic Beam Steering radar, a Synthetic Aperture Radar (SAR), adaptive and/or cognitive radars that change their transmission according to the environment and/or ego state, a reflect array radar, or the like.

In some demonstrative aspects, radar device 101 may include an antenna arrangement 102, a radar frontend 103 configured to communicate radar signals via the antenna arrangement 102, and a radar processor 104 configured to generate radar information based on the radar signals, e.g., as described below.

In some demonstrative aspects, radar processor 104 may be configured to process radar information of radar device 101 and/or to control one or more operations of radar device 101, e.g., as described below.

In some demonstrative aspects, radar processor 104 may include, or may be implemented, partially or entirely, by circuitry and/or logic, e.g., one or more processors including circuitry and/or logic, memory circuitry and/or logic. Additionally or alternatively, one or more functionalities of radar processor 104 may be implemented by logic, which may be executed by a machine and/or one or more processors, e.g., as described below.

In one example, radar processor 104 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In other aspects, radar processor 104 may be implemented by one or more additional or alternative elements of vehicle 100.

In some demonstrative aspects, radar frontend 103 may include, for example, one or more (radar) transmitters, and one or more (radar) receivers, e.g., as described below.

In some demonstrative aspects, antenna arrangement 102 may include a plurality of antennas to communicate the radar signals. For example, antenna arrangement 102 may include multiple transmit antennas in the form of a transmit antenna array, and multiple receive antennas in the form of a receive antenna array. In another example, antenna arrangement 102 may include one or more antennas used both as transmit and receive antennas. In the latter case, the radar frontend 103, for example, may include a duplexer or a circulator, e.g., a circuit to separate transmitted signals from received signals.

In some demonstrative aspects, as shown in FIG. 1, the radar frontend 103 and the antenna arrangement 102 may be controlled, e.g., by radar processor 104, to transmit a radio transmit signal 105.

In some demonstrative aspects, as shown in FIG. 1, the radio transmit signal 105 may be reflected by an object 106, resulting in an echo 107.

In some demonstrative aspects, the radar device 101 may receive the echo 107, e.g., via antenna arrangement 102 and radar frontend 103, and radar processor 104 may generate radar information, for example, by calculating information about position, radial velocity (Doppler), and/or direction of the object 106, e.g., with respect to vehicle 100.

In some demonstrative aspects, radar processor 104 may be configured to provide the radar information to a vehicle controller 108 of the vehicle 100, e.g., for autonomous driving of the vehicle 100.

In some demonstrative aspects, at least part of the functionality of radar processor 104 may be implemented as part of vehicle controller 108. In other aspects, the functionality of radar processor 104 may be implemented as part of any other element of radar device 101 and/or vehicle 100. In other aspects, radar processor 104 may be implemented, as a separate part of, or as part of any other element of radar device 101 and/or vehicle 100.

In some demonstrative aspects, vehicle controller 108 may be configured to control one or more functionalities, modes of operation, components, devices, systems, and/or elements of vehicle 100.

In some demonstrative aspects, vehicle controller 108 may be configured to control one or more vehicular systems of vehicle 100, e.g., as described below.

In some demonstrative aspects, the vehicular systems may include, for example, a steering system, a braking system, a driving system, and/or any other system of the vehicle 100.

In some demonstrative aspects, vehicle controller 108 may configured to control radar device 101, and/or to process one or parameters, attributes and/or information from radar device 101.

In some demonstrative aspects, vehicle controller 108 may be configured, for example, to control the vehicular systems of the vehicle 100, for example, based on radar information from radar device 101 and/or one or more other sensors of the vehicle 100, e.g., Light Detection and Ranging (LIDAR) sensors, camera sensors, and/or the like.

In one example, vehicle controller 108 may control the steering system, the braking system, and/or any other vehicular systems of vehicle 100, for example, based on the information from radar device 101, e.g., based on one or more objects detected by radar device 101.

In other aspects, vehicle controller 108 may be configured to control any other additional or alternative functionalities of vehicle 100.

Some demonstrative aspects are described herein with respect to a radar device 101 implemented in a vehicle, e.g., vehicle 100. In other aspects a radar device, e.g., radar device 101, may be implemented as part of any other element of a traffic system or network, for example, as part of a road infrastructure, and/or any other element of a traffic network or system. Other aspects may be implemented with respect to any other system, environment, and/or apparatus, which may be implemented in any other object, environment, location, or place. For example, radar device 101 may be part of a non-vehicular device, which may be implemented, for example, in an indoor location, a stationary infrastructure outdoors, or any other location.

In some demonstrative aspects, radar device 101 may be configured to support security usage. In one example, radar device 101 may be configured to determine a nature of an operation, e.g., a human entry, an animal entry, an environmental movement, and the like, to identity a threat level of a detected event, and/or any other additional or alternative operations.

Some demonstrative aspects may be implemented with respect to any other additional or alternative devices and/or systems, for example, for a robot, e.g., as described below.

In other aspects, radar device 101 may be configured to support any other usages and/or applications.

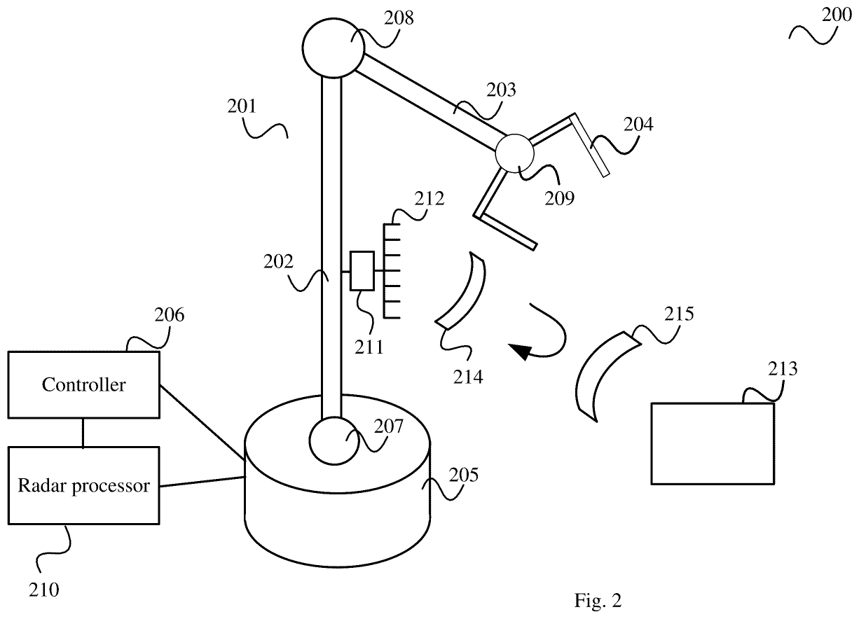

Reference is now made to FIG. 2, which schematically illustrates a block diagram of a robot 200 implementing a radar, in accordance with some demonstrative aspects.

In some demonstrative aspects, robot 200 may include a robot arm 201. The robot 200 may be implemented, for example, in a factory for handling an object 213, which may be, for example, a part that should be affixed to a product that is being manufactured. The robot arm 201 may include a plurality of movable members, for example, movable members 202, 203, 204, and a support 205. Moving the movable members 202, 203, and/or 204 of the robot arm 201, e.g., by actuation of associated motors, may allow physical interaction with the environment to carry out a task, e.g., handling the object 213.

In some demonstrative aspects, the robot arm 201 may include a plurality of joint elements, e.g., joint elements 207, 208, 209, which may connect, for example, the members 202, 203, and/or 204 with each other, and with the support 205. For example, a joint element 207, 208, 209 may have one or more joints, each of which may provide rotatable motion, e.g., rotational motion, and/or translatory motion, e.g., displacement, to associated members and/or motion of members relative to each other. The movement of the members 202, 203, 204 may be initiated by suitable actuators.

In some demonstrative aspects, the member furthest from the support 205, e.g., member 204, may also be referred to as the end-effector 204 and may include one or more tools, such as, a claw for gripping an object, a welding tool, or the like. Other members, e.g., members 202, 203, closer to the support 205, may be utilized to change the position of the end-effector 204, e.g., in three-dimensional space. For example, the robot arm 201 may be configured to function similarly to a human arm, e.g., possibly with a tool at its end.

In some demonstrative aspects, robot 200 may include a (robot) controller 206 configured to implement interaction with the environment, e.g., by controlling the robot arm's actuators, according to a control program, for example, in order to control the robot arm 201 according to the task to be performed.

In some demonstrative aspects, an actuator may include a component adapted to affect a mechanism or process in response to being driven. The actuator can respond to commands given by the controller 206 (the so-called activation) by performing mechanical movement. This means that an actuator, typically a motor (or electromechanical converter), may be configured to convert electrical energy into mechanical energy when it is activated (i.e., actuated).

In some demonstrative aspects, controller 206 may be in communication with a radar processor 210 of the robot 200.

In some demonstrative aspects, a radar fronted 211 and a radar antenna arrangement 212 may be coupled to the radar processor 210. In one example, radar fronted 211 and/or radar antenna arrangement 212 may be included, for example, as part of the robot arm 201.

In some demonstrative aspects, the radar frontend 211, the radar antenna arrangement 212 and the radar processor 210 may be operable as, and/or may be configured to form, a radar device. For example, antenna arrangement 212 may be configured to perform one or more functionalities of antenna arrangement 102 (FIG. 1), radar frontend 211 may be configured to perform one or more functionalities of radar frontend 103 (FIG. 1), and/or radar processor 210 may be configured to perform one or more functionalities of radar processor 104 (FIG. 1), e.g., as described above.

In some demonstrative aspects, for example, the radar frontend 211 and the antenna arrangement 212 may be controlled, e.g., by radar processor 210, to transmit a radio transmit signal 214.

In some demonstrative aspects, as shown in FIG. 2, the radio transmit signal 214 may be reflected by the object 213, resulting in an echo 215.

In some demonstrative aspects, the echo 215 may be received, e.g., via antenna arrangement 212 and radar frontend 211, and radar processor 210 may generate radar information, for example, by calculating information about position, speed (Doppler) and/or direction of the object 213, e.g., with respect to robot arm 201.

In some demonstrative aspects, radar processor 210 may be configured to provide the radar information to the robot controller 206 of the robot arm 201, e.g., to control robot arm 201. For example, robot controller 206 may be configured to control robot arm 201 based on the radar information, e.g., to grab the object 213 and/or to perform any other operation.

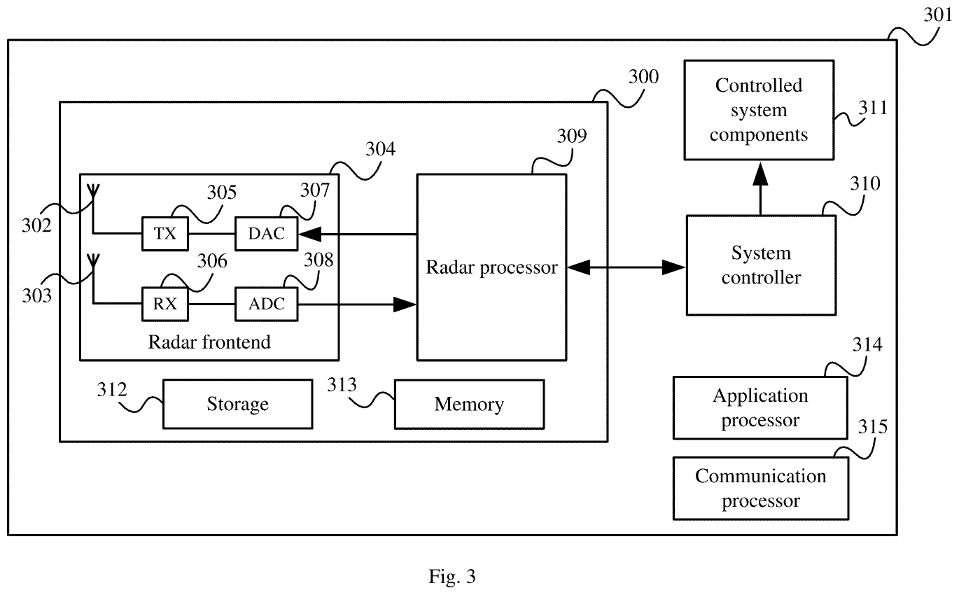

Reference is made to FIG. 3, which schematically illustrates a radar apparatus 300, in accordance with some demonstrative aspects.

In some demonstrative aspects, radar apparatus 300 may be implemented as part of a device or system 301, e.g., as described below.

For example, radar apparatus 300 may be implemented as part of, and/or may configured to perform one or more operations and/or functionalities of, the devices or systems described above with reference to FIG. 1 and/or FIG. 2. In other aspects, radar apparatus 300 may be implemented as part of any other device or system 301.

In some demonstrative aspects, radar device 300 may include an antenna arrangement, which may include one or more transmit antennas 302 and one or more receive antennas 303. In other aspects, any other antenna arrangement may be implemented.

In some demonstrative aspects, radar device 300 may include a radar frontend 304, and a radar processor 309.

In some demonstrative aspects, as shown in FIG. 3, the one or more transmit antennas 302 may be coupled with a transmitter (or transmitter arrangement) 305 of the radar frontend 304; and/or the one or more receive antennas 303 may be coupled with a receiver (or receiver arrangement) 306 of the radar frontend 304, e.g., as described below.

In some demonstrative aspects, transmitter 305 may include one or more elements, for example, an oscillator, a power amplifier and/or one or more other elements, configured to generate radio transmit signals to be transmitted by the one or more transmit antennas 302, e.g., as described below.

In some demonstrative aspects, for example, radar processor 309 may provide digital radar transmit data values to the radar frontend 304. For example, radar frontend 304 may include a Digital-to-Analog Converter (DAC) 307 to convert the digital radar transmit data values to an analog transmit signal. The transmitter 305 may convert the analog transmit signal to a radio transmit signal which is to be transmitted by transmit antennas 302.

In some demonstrative aspects, receiver 306 may include one or more elements, for example, one or more mixers, one or more filters and/or one or more other elements, configured to process, down-convert, radio signals received via the one or more receive antennas 303, e.g., as described below.

In some demonstrative aspects, for example, receiver 306 may convert a radio receive signal received via the one or more receive antennas 303 into an analog receive signal. The radar frontend 304 may include an Analog-to-Digital Converter (ADC) 308 to generate digital radar reception data values based on the analog receive signal. For example, radar frontend 304 may provide the digital radar reception data values to the radar processor 309.

In some demonstrative aspects, radar processor 309 may be configured to process the digital radar reception data values, for example, to detect one or more objects, e.g., in an environment of the device/system 301. This detection may include, for example, the determination of information including one or more of range, speed (Doppler), direction, and/or any other information, of one or more objects, e.g., with respect to the system 301.

In some demonstrative aspects, radar processor 309 may be configured to provide the determined radar information to a system controller 310 of device/system 301. For example, system controller 310 may include a vehicle controller, e.g., if device/system 301 includes a vehicular device/system, a robot controller, e.g., if device/system 301 includes a robot device/system, or any other type of controller for any other type of device/system 301.

In some demonstrative aspects, the radar information from radar processor 309 may be processed, e.g., by system controller 310 and/or any other element of system 301, for example, in combination with information from one or more other of information sources, for example, LiDAR information from a LiDAR processor, vision information from a vision-based processor, or the like.

In some demonstrative aspects, an environmental model of an environment of system 301 may be determined, e.g., by system controller 310 and/or any other element of system 301, for example, based on the radar information from radar processor 309, and/or the information from one or more other of information sources.

In some demonstrative aspects, a driving policy system, e.g., which may be implemented by system controller 310 and/or any other element of system 301, may process the environmental model, for example, to decide on one or more actions, which may be taken.

In some demonstrative aspects, system controller 310 may be configured to control one or more controlled system components 311 of the system 301, e.g., a motor, a brake, steering, and the like, e.g., by one or more corresponding actuators, for example, based on the one or more action decisions.

In some demonstrative aspects, radar device 300 may include a storage 312 or a memory 313, e.g., to store information processed by radar 300, for example, digital radar reception data values being processed by the radar processor 309, radar information generated by radar processor 309, and/or any other data to be processed by radar processor 309.

In some demonstrative aspects, device/system 301 may include, for example, an application processor 314 and/or a communication processor 315, for example, to at least partially implement one or more functionalities of system controller 310 and/or to perform communication between system controller 310, radar device 300, the controlled system components 311, and/or one or more additional elements of device/system 301.

In some demonstrative aspects, radar device 300 may be configured to generate and transmit the radio transmit signal in a form, which may support determination of range, speed, and/or direction, e.g., as described below.

For example, a radio transmit signal of a radar may be configured to include a plurality of pulses. For example, a pulse transmission may include the transmission of short high-power bursts in combination with times during which the radar device listens for echoes.

For example, in order to more optimally support a highly dynamic situation, e.g., in an automotive scenario, a continuous wave (CW) may instead be used as the radio transmit signal. However, a continuous wave, e.g., with constant frequency, may support velocity determination, but may not allow range determination, e.g., due to the lack of a time mark that could allow distance calculation.

In some demonstrative aspects, radio transmit signal 105 (FIG. 1) may be transmitted according to technologies such as, for example, Frequency-Modulated Continuous Wave (FMCW) radar, Phase-Modulated Continuous Wave (PMCW) radar, Orthogonal Frequency Division Multiplexing (OFDM) radar, and/or any other type of radar technology, which may support determination of range, velocity, and/or direction, e.g., as described below.

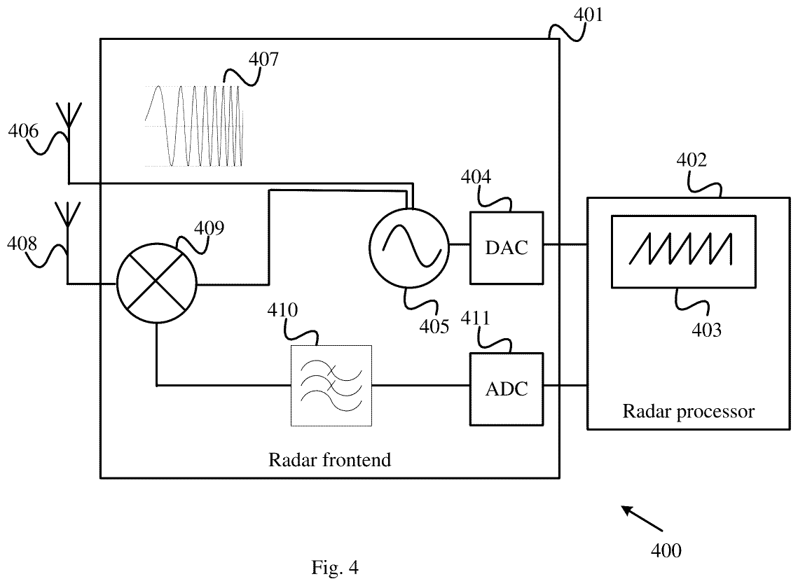

Reference is made to FIG. 4, which schematically illustrates a FMCW radar apparatus, in accordance with some demonstrative aspects.

In some demonstrative aspects, FMCW radar device 400 may include a radar frontend 401, and a radar processor 402. For example, radar frontend 304 (FIG. 3) may include one or more elements of, and/or may perform one or more operations and/or functionalities of, radar frontend 401; and/or radar processor 309 (FIG. 3) may include one or more elements of, and/or may perform one or more operations and/or functionalities of, radar processor 402.

In some demonstrative aspects, FMCW radar device 400 may be configured to communicate radio signals according to an FMCW radar technology, e.g., rather than sending a radio transmit signal with a constant frequency.

In some demonstrative aspects, radio frontend 401 may be configured to ramp up and reset the frequency of the transmit signal, e.g., periodically, for example, according to a saw tooth waveform 403. In other aspects, a triangle waveform, or any other suitable waveform may be used.

In some demonstrative aspects, for example, radar processor 402 may be configured to provide waveform 403 to frontend 401, for example, in digital form, e.g., as a sequence of digital values.

In some demonstrative aspects, radar frontend 401 may include a DAC 404 to convert waveform 403 into analog form, and to supply it to a voltage-controlled oscillator 405. For example, oscillator 405 may be configured to generate an output signal, which may be frequency-modulated in accordance with the waveform 403.

In some demonstrative aspects, oscillator 405 may be configured to generate the output signal including a radio transmit signal, which may be fed to and sent out by one or more transmit antennas 406.

In some demonstrative aspects, the radio transmit signal generated by the oscillator 405 may have the form of a sequence of chirps 407, which may be the result of the modulation of a sinusoid with the saw tooth waveform 403.

In one example, a chirp 407 may correspond to the sinusoid of the oscillator signal frequency-modulated by a “tooth” of the saw tooth waveform 403, e.g., from the minimum frequency to the maximum frequency.

In some demonstrative aspects, FMCW radar device 400 may include one or more receive antennas 408 to receive a radio receive signal. The radio receive signal may be based on the echo of the radio transmit signal, e.g., in addition to any noise, interference, or the like.

In some demonstrative aspects, radar frontend 401 may include a mixer 409 to mix the radio transmit signal with the radio receive signal into a mixed signal.

In some demonstrative aspects, radar frontend 401 may include a filter, e.g., a Low Pass Filter (LPF) 410, which may be configured to filter the mixed signal from the mixer 409 to provide a filtered signal. For example, radar frontend 401 may include an ADC 411 to convert the filtered signal into digital reception data values, which may be provided to radar processor 402. In another example, the filter 410 may be a digital filter, and the ADC 411 may be arranged between the mixer 409 and the filter 410.

In some demonstrative aspects, radar processor 402 may be configured to process the digital reception data values to provide radar information, for example, including range, speed (velocity/Doppler), and/or direction (AoA) information of one or more objects.

In some demonstrative aspects, radar processor 402 may be configured to perform a first Fast Fourier Transform (FFT) (also referred to as “range FFT”) to extract a delay response, which may be used to extract range information, and/or a second FFT (also referred to as “Doppler FFT”) to extract a Doppler shift response, which may be used to extract velocity information, from the digital reception data values.

In other aspects, any other additional or alternative methods may be utilized to extract range information. In one example, in a digital radar implementation, a correlation with the transmitted signal may be used, e.g., according to a matched filter implementation.

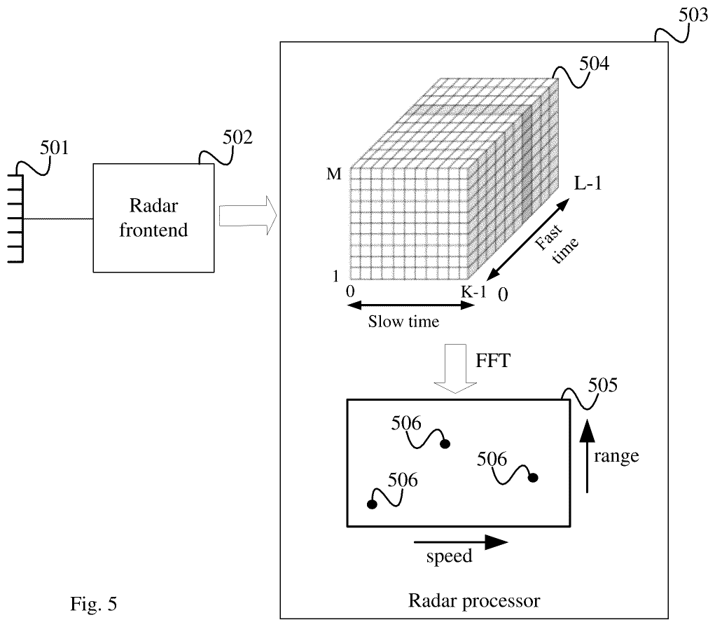

Reference is made to FIG. 5, which schematically illustrates an extraction scheme, which may be implemented to extract range and speed (Doppler) estimations from digital reception radar data values, in accordance with some demonstrative aspects. For example, radar processor 104 (FIG. 1), radar processor 210 (FIG. 2), radar processor 309 (FIG. 3), and/or radar processor 402 (FIG. 4), may be configured to extract range and/or speed (Doppler) estimations from digital reception radar data values according to one or more aspects of the extraction scheme of FIG. 5.

In some demonstrative aspects, as shown in FIG. 5, a radio receive signal, e.g., including echoes of a radio transmit signal, may be received by a receive antenna array 501. The radio receive signal may be processed by a radio radar frontend 502 to generate digital reception data values, e.g., as described above. The radio radar frontend 502 may provide the digital reception data values to a radar processor 503, which may process the digital reception data values to provide radar information, e.g., as described above.

In some demonstrative aspects, the digital reception data values may be represented in the form of a data cube 504. For example, the data cube 504 may include digitized samples of the radio receive signal, which is based on a radio signal transmitted from a transmit antenna and received by M receive antennas. In some demonstrative aspects, for example, with respect to a MIMO implementation, there may be multiple transmit antennas, and the number of samples may be multiplied accordingly.

In some demonstrative aspects, a layer of the data cube 504, for example, a horizontal layer of the data cube 504, may include samples of an antenna, e.g., a respective antenna of the M antennas.

In some demonstrative aspects, data cube 504 may include samples for K chirps. For example, as shown in FIG. 5, the samples of the chirps may be arranged in a so-called “slow time”-direction.

In some demonstrative aspects, the data cube 504 may include L samples, e.g., L=512 or any other number of samples, for a chirp, e.g., per each chirp. For example, as shown in FIG. 5, the samples per chirp may be arranged in a so-called “fast time”-direction of the data cube 504.

In some demonstrative aspects, radar processor 503 may be configured to process a plurality of samples, e.g., L samples collected for each chirp and for each antenna, by a first FFT. The first FFT may be performed, for example, for each chirp and each antenna, such that a result of the processing of the data cube 504 by the first FFT may again have three dimensions, and may have the size of the data cube 504 while including values for L range bins, e.g., instead of the values for the L sampling times.

In some demonstrative aspects, radar processor 503 may be configured to process the result of the processing of the data cube 504 by the first FFT, for example, by processing the result according to a second FFT along the chirps, e.g., for each antenna and for each range bin.

For example, the first FFT may be in the “fast time” direction, and the second FFT may be in the “slow time” direction.

In some demonstrative aspects, the result of the second FFT may provide, e.g., when aggregated over the antennas, a range/Doppler (R/D) map 505. The R/D map may have FFT peaks 506, for example, including peaks of FFT output values (in terms of absolute values) for certain range/speed combinations, e.g., for range/Doppler bins. For example, a range/Doppler bin may correspond to a range bin and a Doppler bin. For example, radar processor 503 may consider a peak as potentially corresponding to an object, e.g., of the range and speed corresponding to the peak's range bin and speed bin.

In some demonstrative aspects, the extraction scheme of FIG. 5 may be implemented for an FMCW radar, e.g., FMCW radar 400 (FIG. 4), as described above. In other aspects, the extraction scheme of FIG. 5 may be implemented for any other radar type. In one example, the radar processor 503 may be configured to determine a range/Doppler map 505 from digital reception data values of a PMCW radar, an OFDM radar, or any other radar technologies. For example, in adaptive or cognitive radar, the pulses in a frame, the waveform and/or modulation may be changed over time, e.g., according to the environment.

Referring back to FIG. 3, in some demonstrative aspects, receive antenna arrangement 303 may be implemented using a receive antenna array having a plurality of receive antennas (or receive antenna elements). For example, radar processor 309 may be configured to determine an angle of arrival of the received radio signal, e.g., echo 107 (FIG. 1) and/or echo 215 (FIG. 2). For example, radar processor 309 may be configured to determine a direction of a detected object, e.g., with respect to the device/system 301, for example, based on the angle of arrival of the received radio signal, e.g., as described below.

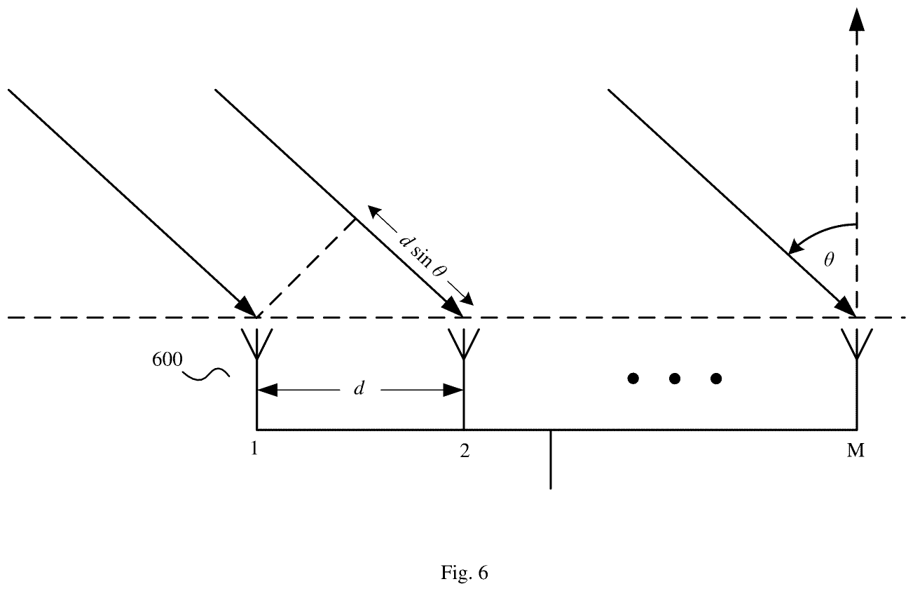

Reference is made to FIG. 6, which schematically illustrates an angle-determination scheme, which may be implemented to determine Angle of Arrival (AoA) information based on an incoming radio signal received by a receive antenna array 600, in accordance with some demonstrative aspects.

FIG. 6 depicts an angle-determination scheme based on received signals at the receive antenna array.

In some demonstrative aspects, for example, in a virtual MIMO array, the angle-determination may also be based on the signals transmitted by the array of Tx antennas.

FIG. 6 depicts a one-dimensional angle-determination scheme. Other multi-dimensional angle determination schemes, e.g., a two-dimensional scheme or a three-dimensional scheme, may be implemented.

In some demonstrative aspects, as shown in FIG. 6, the receive antenna array 600 may include M antennas (numbered, from left to right, 1 to M).

As shown by the arrows in FIG. 6, it is assumed that an echo is coming from an object located at the top left direction. Accordingly, the direction of the echo, e.g., the incoming radio signal, may be towards the bottom right. According to this example, the further to the left a receive antenna is located, the earlier it will receive a certain phase of the incoming radio signal.

For example, a phase difference, denoted Δφ, between two antennas of the receive antenna array 600 may be determined, e.g., as follows:

$$Δφ = \frac{2 π}{λ} \cdot d \cdot sin ( θ )$$

wherein λ denotes a wavelength of the incoming radio signal, d denotes a distance between the two antennas, and θ denotes an angle of arrival of the incoming radio signal, e.g., with respect to a normal direction of the array.

In some demonstrative aspects, radar processor 309 (FIG. 3) may be configured to utilize this relationship between phase and angle of the incoming radio signal, for example, to determine the angle of arrival of echoes, for example by performing an FFT, e.g., a third FFT (“angular FFT”) over the antennas.

In some demonstrative aspects, multiple transmit antennas, e.g., in the form of an antenna array having multiple transmit antennas, may be used, for example, to increase the spatial resolution, e.g., to provide high-resolution radar information. For example, a MIMO radar device may utilize a virtual MIMO radar antenna, which may be formed as a convolution of a plurality of transmit antennas convolved with a plurality of receive antennas.

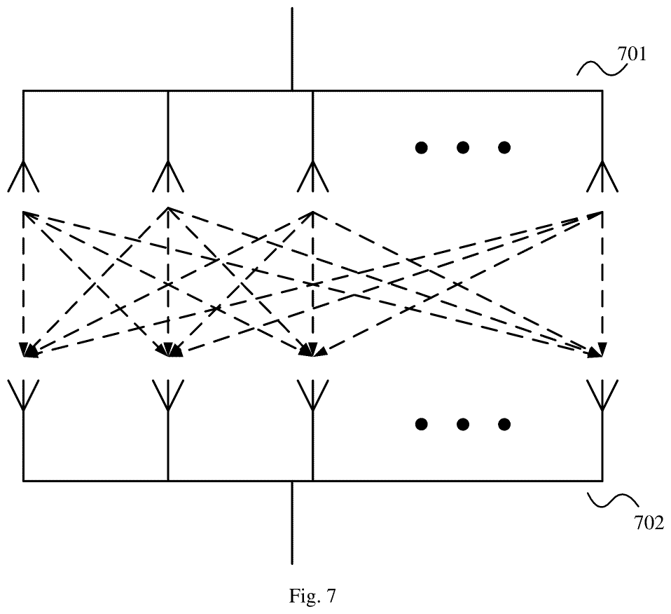

Reference is made to FIG. 7, which schematically illustrates a MIMO radar antenna scheme, which may be implemented based on a combination of Transmit (Tx) and Receive (Rx) antennas, in accordance with some demonstrative aspects.

In some demonstrative aspects, as shown in FIG. 7, a radar MIMO arrangement may include a transmit antenna array 701 and a receive antenna array 702. For example, the one or more transmit antennas 302 (FIG. 3) may be implemented to include transmit antenna array 701, and/or the one or more receive antennas 303 (FIG. 3) may be implemented to include receive antenna array 702.

In some demonstrative aspects, antenna arrays including multiple antennas both for transmitting the radio transmit signals and for receiving echoes of the radio transmit signals, may be utilized to provide a plurality of virtual channels as illustrated by the dashed lines in FIG. 7. For example, a virtual channel may be formed as a convolution, for example, as a Kronecker product, between a transmit antenna and a receive antenna, e.g., representing a virtual steering vector of the MIMO radar.

In some demonstrative aspects, a transmit antenna, e.g., each transmit antenna, may be configured to send out an individual radio transmit signal, e.g., having a phase associated with the respective transmit antenna.

For example, an array of N transmit antennas and M receive antennas may be implemented to provide a virtual MIMO array of size N×M. For example, the virtual MIMO array may be formed according to the Kronecker product operation applied to the Tx and Rx steering vectors.

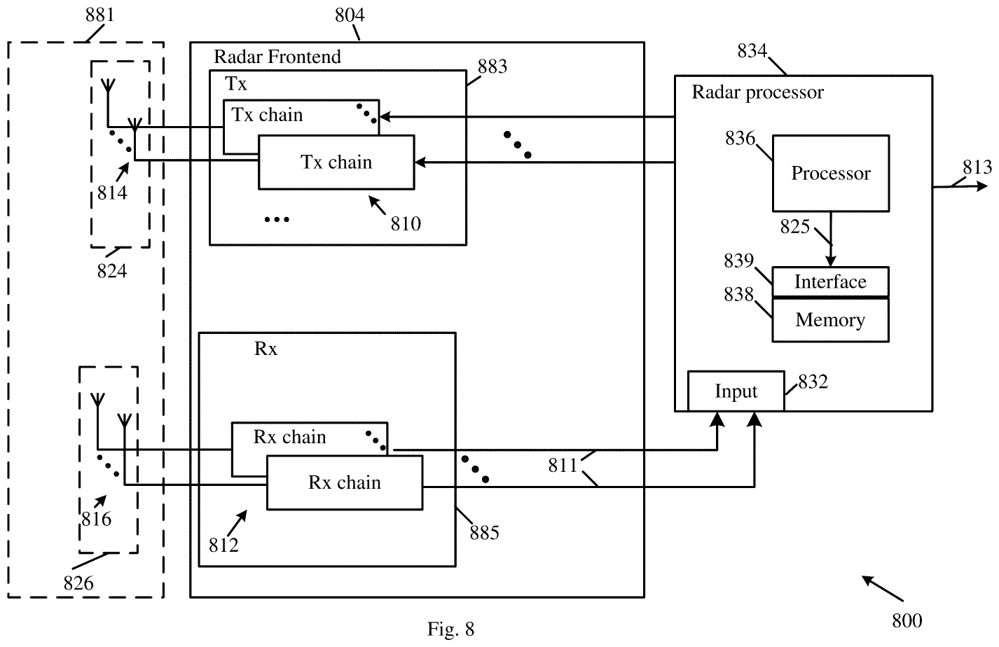

FIG. 8 is a schematic block diagram illustration of elements of a radar device 800, in accordance with some demonstrative aspects. For example, radar device 101 (FIG. 1), radar device 300 (FIG. 3), and/or radar device 400 (FIG. 4), may include one or more elements of radar device 800, and/or may perform one or more operations and/or functionalities of radar device 800.

In some demonstrative aspects, as shown in FIG. 8, radar device 800 may include a radar frontend 804 and a radar processor 834. For example, radar frontend 103 (FIG. 1), radar frontend 211 (FIG. 1), radar frontend 304 (FIG. 3), radar frontend 401 (FIG. 4), and/or radar frontend 502 (FIG. 5), may include one or more elements of radar frontend 804, and/or may perform one or more operations and/or functionalities of radar frontend 804.

In some demonstrative aspects, radar frontend 804 may be implemented as part of a MIMO radar utilizing a MIMO radar antenna 881 including a plurality of Tx antennas 814 configured to transmit a plurality of Tx RF signals (also referred to as “Tx radar signals”); and a plurality of Rx antennas 816 configured to receive a plurality of Rx RF signals (also referred to as “Rx radar signals”), for example, based on the Tx radar signals, e.g., as described below.

In some demonstrative aspects, MIMO antenna array 881, antennas 814, and/or antennas 816 may include or may be part of any type of antennas suitable for transmitting and/or receiving radar signals. For example, MIMO antenna array 881, antennas 814, and/or antennas 816, may be implemented as part of any suitable configuration, structure, and/or arrangement of one or more antenna elements, components, units, assemblies, and/or arrays. For example, MIMO antenna array 881, antennas 814, and/or antennas 816, may be implemented as part of a phased array antenna, a multiple element antenna, a set of switched beam antennas, and/or the like. In some aspects, MIMO antenna array 881, antennas 814, and/or antennas 816, may be implemented to support transmit and receive functionalities using separate transmit and receive antenna elements. In some aspects, MIMO antenna array 881, antennas 814, and/or antennas 816, may be implemented to support transmit and receive functionalities using common and/or integrated transmit/receive elements.

In some demonstrative aspects, MIMO radar antenna 881 may include a rectangular MIMO antenna array, and/or curved array, e.g., shaped to fit a vehicle design.

In other aspects, any other form, shape, and/or arrangement of MIMO radar antenna 881 may be implemented.

In some demonstrative aspects, radar frontend 804 may include one or more radios configured to generate and transmit the Tx RF signals via Tx antennas 814; and/or to process the Rx RF signals received via Rx antennas 816, e.g., as described below.

In some demonstrative aspects, radar frontend 804 may include at least one transmitter (Tx) 883 including circuitry and/or logic configured to generate and/or transmit the Tx radar signals via Tx antennas 814.

In some demonstrative aspects, radar frontend 804 may include at least one receiver (Rx) 885 including circuitry and/or logic to receive and/or process the Rx radar signals received via Rx antennas 816, for example, based on the Tx radar signals.

In some demonstrative aspects, transmitter 883, and/or receiver 885 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like.

In some demonstrative aspects, transmitter 883 may include a plurality of Tx chains 810 configured to generate and transmit the Tx RF signals via Tx antennas 814, e.g., respectively; and/or receiver 885 may include a plurality of Rx chains 812 configured to receive and process the Rx RF signals received via the Rx antennas 816, e.g., respectively.

In some demonstrative aspects, radar processor 834 may be configured to generate radar information 813, for example, based on the radar signals communicated by MIMO radar antenna 881, e.g., as described below. For example, radar processor 104 (FIG. 1), radar processor 210 (FIG. 2), radar processor 309 (FIG. 3), radar processor 402 (FIG. 4), and/or radar processor 503 (FIG. 5), may include one or more elements of radar processor 834, and/or may perform one or more operations and/or functionalities of radar processor 834.

In some demonstrative aspects, radar processor 834 may be configured to generate radar information 813, for example, based on radar Rx data 811 received from the plurality of Rx chains 812. For example, radar Rx data 811 may be based on the radar Rx signals received via the Rx antennas 816.

In some demonstrative aspects, radar processor 834 may include an input 832 to receive radar input data, e.g., including the radar Rx data 811 from the plurality of Rx chains 812.

In some demonstrative aspects, radar processor 834 may include, or may be implemented, partially or entirely, by circuitry and/or logic, e.g., one or more processors including circuitry and/or logic, memory circuitry and/or logic. Additionally or alternatively, one or more functionalities of radar processor 834 may be implemented by logic, which may be executed by a machine and/or one or more processors, e.g., as described below.

In some demonstrative aspects, radar processor 834 may include at least one processor 836, which may be configured, for example, to process the radar Rx data 811, and/or to perform one or more operations, methods, and/or algorithms.

In some demonstrative aspects, radar processor 834 may include at least one memory 838, e.g., coupled to the processor 836. For example, memory 838 may be configured to store data processed by radar processor 834. For example, memory 838 may store, e.g., at least temporarily, at least some of the information processed by the processor 836, and/or logic to be utilized by the processor 836.

In some demonstrative aspects, processor 836 may interface with memory 838, for example, via a memory interface 839.

In some demonstrative aspects, processor 836 may be configured to access memory 838, e.g., to write data to memory 838 and/or to read data from memory 838, for example, via memory interface 839.

In some demonstrative aspects, memory 838 may be configured to store at least part of the radar data, e.g., some of the radar Rx data or all of the radar Rx data, for example, for processing by processor 836, e.g., as described below.

In some demonstrative aspects, memory 838 may be configured to store processed data, which may be generated by processor 836, for example, during the process of generating the radar information 813, e.g., as described below.

In some demonstrative aspects, memory 838 may be configured to store range information and/or Doppler information, which may be generated by processor 836, for example, based on the radar Rx data. In one example, the range information and/or Doppler information may be determined based on a Cross-Correlation (XCORR) operation, which may be applied to the radar Rx data. Any other additional or alternative operation, algorithm, and/or procedure may be utilized to generate the range information and/or Doppler information.

In some demonstrative aspects, memory 838 may be configured to store AoA information, which may be generated by processor 836, for example, based on the radar Rx data, the range information and/or Doppler information. In one example, the AoA information may be determined based on an AoA estimation algorithm. Any other additional or alternative operation, algorithm, and/or procedure may be utilized to generate the AoA information.

In some demonstrative aspects, radar processor 834 may be configured to generate the radar information 813 including one or more of range information, Doppler information, and/or AoA information.

In some demonstrative aspects, the radar information 813 may include Point Cloud 1 (PC1) information, for example, including raw point cloud estimations, e.g., Range, Radial Velocity, Azimuth, and/or Elevation.

In some demonstrative aspects, the radar information 813 may include additional information, which may be, for example, based on the raw point cloud estimations, and/or may be related to the raw point cloud estimations.

In some demonstrative aspects, the radar information 813 may include metadata information corresponding to the raw point cloud estimations.

In some demonstrative aspects, the radar information 813 may include, for example, information relating to a reliability level of the raw point cloud estimations, information relating to one or more parameters, conditions and/or criteria implemented in determining the raw point cloud estimations, and/or any other suitable additional or alternative information.

For example, the radar information 813 may include Log Likelihood Ratio (LLR) information corresponding to the raw point cloud estimations, Radar Cross Section (RCS) estimation information, Signal to Noise Ratio (SNR) estimation information, and/or any other suitable additional or alternative information.

In some demonstrative aspects, the radar information 813 may include Point Cloud 2 (PC2) information, which may be generated, for example, based on the PC1 information. For example, the PC2 information may include clustering information, tracking information, e.g., tracking of probabilities and/or density functions, bounding box information, classification information, orientation information, and the like. In one example, the PC2 information may be based on one or more temporal filtering techniques, which may be applied to the PC1 information, for example, for temporal filtering of multiple frames and/or multiple PC1 instances.

In some demonstrative aspects, the radar information 813 may include target tracking information corresponding to a plurality of targets in an environment of the radar device 800, e.g., as described below.

In some demonstrative aspects, radar processor 834 may be configured to generate the radar information 813 in the form of four Dimensional (4D) image information, e.g., a cube, which may represent 4D information corresponding to one or more detected targets.

In some demonstrative aspects, the 4D image information may include, for example, range values, e.g., based on the range information, velocity values, e.g., based on the Doppler information, azimuth values, e.g., based on azimuth AoA information, elevation values, e.g., based on elevation AoA information, and/or any other values.

In some demonstrative aspects, radar processor 834 may be configured to generate the radar information 813 in any other form, and/or including any other additional or alternative information.

In some demonstrative aspects, radar processor 834 may be configured to process the signals communicated via MIMO radar antenna 881 as signals of a virtual MIMO array formed by a convolution of the plurality of Rx antennas 816 and the plurality of Tx antennas 814.

In some demonstrative aspects, radar frontend 804 and/or radar processor 834 may be configured to utilize MIMO techniques, for example, to support a reduced physical array aperture, e.g., an array size, and/or utilizing a reduced number of antenna elements. For example, radar frontend 804 and/or radar processor 834 may be configured to transmit orthogonal signals via one or more Tx arrays 824 including a plurality of N elements, e.g., Tx antennas 814, and processing received signals via one or more Rx arrays 826 including a plurality of M elements, e.g., Rx antennas 816.

In some demonstrative aspects, utilizing the MIMO technique of transmission of the orthogonal signals from the Tx arrays 824 with N elements and processing the received signals in the Rx arrays 826 with M elements may be equivalent, e.g., under a far field approximation, to a radar utilizing transmission from one antenna and reception with N*M antennas. For example, radar frontend 804 and/or radar processor 834 may be configured to utilize MIMO antenna array 881 as a virtual array having an equivalent array size of N*M, which may define locations of virtual elements, for example, as a convolution of locations of physical elements, e.g., the antennas 814 and/or 816.

In some demonstrative aspects, a radar system may include a plurality of radar devices 800. For example, vehicle 100 (FIG. 1) may include a plurality of radar devices 800, e.g., as described below.

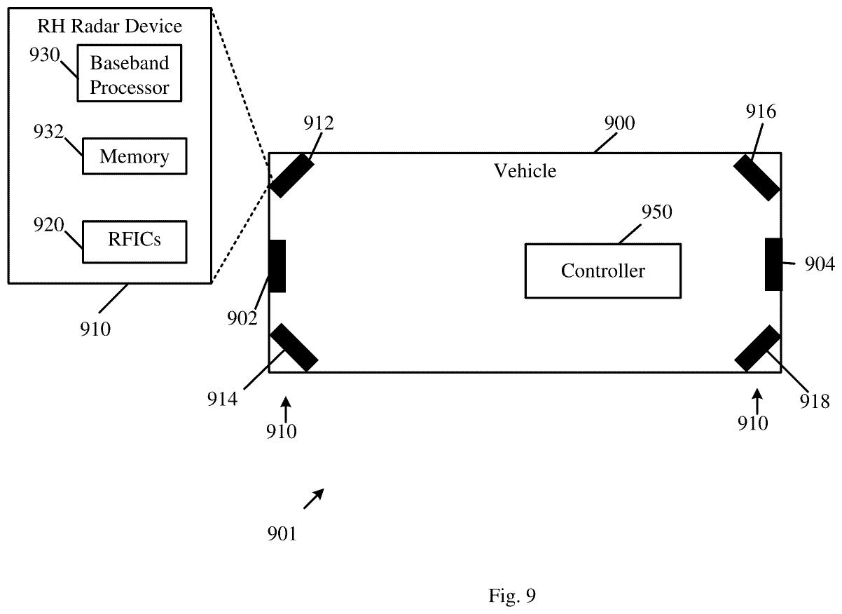

Reference is made to FIG. 9, which schematically illustrates a radar system 901 including a plurality of Radio Head (RH) radar devices (also referred to as RHs) 910 implemented in a vehicle 900, in accordance with some demonstrative aspects.

In some demonstrative aspects, as shown in FIG. 9, the plurality of RH radar devices 910 may be located, for example, at a plurality of positions around vehicle 900, for example, to provide radar sensing at a large field of view around vehicle 900, e.g., as described below.

In some demonstrative aspects, as shown in FIG. 9, the plurality of RH radar devices 910 may include, for example, six RH radar devices 910, e.g., as described below.

In some demonstrative aspects, the plurality of RH radar devices 910 may be located, for example, at a plurality of positions around vehicle 900, which may be configured to support 360-degrees radar sensing, e.g., a field of view of 360 degrees surrounding the vehicle 900, e.g., as described below.

In one example, the 360-degrees radar sensing may allow to provide a radar-based view of substantially all surroundings around vehicle 900, e.g., as described below.

In other aspects, the plurality of RH radar devices 910 may include any other number of RH radar devices 910, e.g., less than six radar devices or more than six radar devices.

In other aspects, the plurality of RH radar devices 910 may be positioned at any other locations and/or according to any other arrangement, which may support radar sensing at any other field of view around vehicle 900, e.g., 360-degrees radar sensing or radar sensing of any other field of view.

In some demonstrative aspects, as shown in FIG. 9, vehicle 900 may include a first RH radar device 902, e.g., a front RH, at a front-side of vehicle 900.

In some demonstrative aspects, as shown in FIG. 9, vehicle 900 may include a second RH radar device 904, e.g., a back RH, at a back-side of vehicle 900.

In some demonstrative aspects, as shown in FIG. 9, vehicle 900 may include one or more of RH radar devices at one or more respective corners of vehicle 900. For example, vehicle 900 may include a first corner RH radar device 912 at a first corner of vehicle 900, a second corner RH radar device 914 at a second corner of vehicle 900, a third corner RH radar device 916 at a third corner of vehicle 900, and/or a fourth corner RH radar device 918 at a fourth corner of vehicle 900.

In some demonstrative aspects, vehicle 900 may include one, some, or all, of the plurality of RH radar devices 910 shown in FIG. 9. For example, vehicle 900 may include the front RH radar device 902 and/or back RH radar device 904.

In other aspects, vehicle 900 may include any other additional or alternative radar devices, for example, at any other additional or alternative positions around vehicle 900. In one example, vehicle 900 may include a side radar, e.g., on a side of vehicle 900.

In some demonstrative aspects, as shown in FIG. 9, vehicle 900 may include a radar system controller 950 configured to control one or more, e.g., some or all, of the RH radar devices 910.

In some demonstrative aspects, at least part of the functionality of radar system controller 950 may be implemented by a dedicated controller, e.g., a dedicated system controller or central controller, which may be separate from the RH radar devices 910, and may be configured to control some or all of the RH radar devices 910.

In some demonstrative aspects, at least part of the functionality of radar system controller 950 may be implemented as part of at least one RH radar device 910.

In some demonstrative aspects, at least part of the functionality of radar system controller 950 may be implemented by a radar processor of an RH radar device 910. For example, radar processor 834 (FIG. 8) may include one or more elements of radar system controller 950, and/or may perform one or more operations and/or functionalities of radar system controller 950.

In some demonstrative aspects, at least part of the functionality of radar system controller 950 may be implemented by a system controller of vehicle 900. For example, vehicle controller 108 (FIG. 1) may include one or more elements of radar system controller 950, and/or may perform one or more operations and/or functionalities of radar system controller 950.

In other aspects, one or more functionalities of system controller 950 may be implemented as part of any other element of vehicle 900.

In some demonstrative aspects, as shown in FIG. 9, an RH radar device 910 of the plurality of RH radar devices 910, may include a baseband processor 930 (also referred to as a “Baseband Processing Unit (BPU)”), which may be configured to control communication of radar signals by the RH radar device 910, and/or to process radar signals communicated by the RH radar device 910. For example, baseband processor 930 may include one or more elements of radar processor 834 (FIG. 8), and/or may perform one or more operations and/or functionalities of radar processor 834 (FIG. 8).

In other aspects, an RH radar device 910 of the plurality of RH radar devices 910 may exclude one or more, e.g., some or all, functionalities of baseband processor 930. For example, controller 950 may be configured to perform one or more, e.g., some or all, functionalities of the baseband processor 930 for the RH.

In one example, controller 950 may be configured to perform baseband processing for all RH radar devices 910, and all RH radio devices 910 may be implemented without baseband processors 930.

In another example, controller 950 may be configured to perform baseband processing for one or more first RH radar devices 910, and the one or more first RH radio devices 910 may be implemented without baseband processors 930; and/or one or more second RH radar devices 910 may be implemented with one or more functionalities, e.g., some or all functionalities, of baseband processors 930.

In another example, one or more, e.g., some or all, RH radar devices 910 may be implemented with one or more functionalities, e.g., partial functionalities or full functionalities, of baseband processors 930.

In some demonstrative aspects, baseband processor 930 may include one or more components and/or elements configured for digital processing of radar signals communicated by the RH radar device 910, e.g., as described below.

In some demonstrative aspects, baseband processor 930 may include one or more FFT engines, matrix multiplication engines, DSP processors, and/or any other additional or alternative baseband, e.g., digital, processing components.

In some demonstrative aspects, as shown in FIG. 9, RH radar device 910 may include a memory 932, which may be configured to store data processed by, and/or to be processed by, baseband processor 930. For example, memory 932 may include one or more elements of memory 838 (FIG. 8), and/or may perform one or more operations and/or functionalities of memory 838 (FIG. 8).

In some demonstrative aspects, memory 932 may include an internal memory, and/or an interface to one or more external memories, e.g., an external Double Data Rate (DDR) memory, and/or any other type of memory.

In other aspects, an RH radar device 910 of the plurality of RH radar devices 910 may exclude memory 932. For example, the RH radar device 910 may be configured to provide radar data to controller 950, e.g., in the form of raw radar data.

In some demonstrative aspects, as shown in FIG. 9, RH radar device 910 may include one or more RF units, e.g., in the form of one or more RF Integrated Chips (RFICs) 920, which may be configured to communicate radar signals, e.g., as described below.

For example, an RFIC 920 may include one or more elements of front-end 804 (FIG. 8), and/or may perform one or more operations and/or functionalities of front-end 804 (FIG. 8).

In some demonstrative aspects, the plurality of RFICs 920 may be operable to form a radar antenna array including one or more Tx antenna arrays and one or more Rx antenna arrays.

For example, the plurality of RFICs 920 may be operable to form MIMO radar antenna 881 (FIG. 8) including Tx arrays 824 (FIG. 8), and/or Rx arrays 826 (FIG. 8).

In some demonstrative aspects, radar performance of a radar device, e.g., as described above with reference to FIGS. 1-9, may be affected by one or more properties of an antenna array of the radar device, e.g., as described below.

In some demonstrative aspects, the one or more properties of the antenna array of the radar device may be based, for example, on a size of the antenna array and/or on one or more properties of one or more array elements of the antenna array.

For example, there may be one or more technical problems, disadvantages, and/or inefficiencies in an implementation of a fixed phased array antenna having a plurality of fixed and/or identical antenna elements, which have fixed and/or identical radiation patterns across the antenna array.

For example, a beam of the fixed phased array antenna may be steered according to a beam steering mechanism, e.g., to scan an environment.

For example, a number of active antenna elements in the fixed phased array antenna may be controlled, for example, by selectively disabling some of the antenna elements, for example, to control a trade-off between beam focusing of the beam, a power consumption of the phased array antenna, and/or a scanning speed of the phased array antenna.

In one example, one or more antenna elements of the plurality of fixed antenna elements may be disabled, for example, to increase the scanning speed of the phased array antenna, and/or to reduce the power consumption of the phased array antenna.

In another example, a count of active antenna elements in the phased array antenna may be increased, for example, to focus the beam of the phased antenna array.

For example, a radiation pattern of each antenna element in the fixed phased array antenna may be fixed according to a predefined radiation pattern. For example, there may be no ability to change, e.g., to dynamically change, one or more properties of the radiation pattern of the antenna element of the fixed phased array antenna.

In some demonstrative aspects, a device implementing an antenna array, for example, a radar device, e.g., as described above with reference to FIGS. 1-9, may be configured to implement one or more operations and/or functionalities of a radiation-pattern control mechanism, which may be configured to provide a technical solution to support controlling a radiation pattern of the antenna array, e.g., as described below.

In some demonstrative aspects, a device implementing an antenna array, for example, a radar device, e.g., as described above with reference to FIGS. 1-9, may be configured to implement one or more operations and/or functionalities of a radiation-pattern control mechanism, which may be configured to provide a technical solution to support controlling, e.g., dynamically controlling, one or more properties of one or more antenna elements of the antenna array, e.g., as described below.

In some demonstrative aspects, a device implementing an antenna array, for example, a radar device, e.g., as described above with reference to FIGS. 1-9, may be configured to implement one or more operations and/or functionalities of a radiation-pattern control mechanism, which may be configured to provide a technical solution to support controlling, e.g., dynamically controlling, one or more properties of an antenna element, for example, of each antenna element, of the antenna array, e.g., as described below.

In some demonstrative aspects, a device implementing an antenna array, for example, a radar device, e.g., as described above with reference to FIGS. 1-9, may be configured to implement one or more operations and/or functionalities of a radiation-pattern control mechanism, which may be configured, for example, to provide a technical solution to support controlling, e.g., dynamically controlling, one or more properties of an antenna element, for example, of each antenna element, for example, per one or more radar communication and/or processing settings and/or requirements, e.g., as described below.

In some demonstrative aspects, a device implementing an antenna array, for example, a radar device, e.g., as described above with reference to FIGS. 1-9, may be configured to implement one or more operations and/or functionalities of a radiation-pattern control mechanism, which may be configured to provide a technical solution to support controlling, e.g., dynamically controlling, an element factor of one or more antenna elements of the antenna array, e.g., as described below.

In some demonstrative aspects, a device implementing an antenna array, for example, a radar device, e.g., as described above with reference to FIGS. 1-9, may be configured to implement one or more operations and/or functionalities of a radiation-pattern control mechanism, which may be configured to provide a technical solution to support controlling, e.g., dynamically controlling, one or more radiation patterns of one or more antenna elements of the antenna array, e.g., as described below.

In some demonstrative aspects, a device implementing an antenna array, for example, a radar device, e.g., as described above with reference to FIGS. 1-9, may be configured to implement one or more operations and/or functionalities of a radiation-pattern control mechanism, which may be configured to provide a technical solution to support controlling, e.g., dynamically controlling, a radiation pattern of an antenna element, e.g., each antenna element, of the antenna array, e.g., as described below.

In some demonstrative aspects, a device implementing an antenna array, for example, a radar device, e.g., as described above with reference to FIGS. 1-9, may be configured to implement one or more operations and/or functionalities of a radiation-pattern control mechanism to support controlling, e.g., dynamically controlling, the radiation pattern and/or the element factor of one or more antenna elements of the antenna array, for example, to enhance a Signal to Noise Ratio (SNR), and/or a Signal to Interference Ratio (SINR), e.g., as described below.

In some demonstrative aspects, a device implementing an antenna array, for example, a radar device, e.g., as described above with reference to FIGS. 1-9, may be configured to implement one or more operations and/or functionalities of a radiation-pattern control mechanism to support controlling, e.g., dynamically controlling, the radiation pattern and/or the element factor of one or more antenna elements of the antenna array, for example, to support reduced digital processing efforts for processing signals communicated by the antenna array, for example, for a digital radar, e.g., as described below.

In some demonstrative aspects, a device implementing an antenna array, for example, a radar device, e.g., as described above with reference to FIGS. 1-9, may be configured to implement one or more operations and/or functionalities of a radiation-pattern control mechanism, which may be configured to provide a technical solution to support controlling and/or changing, e.g., dynamically controlling and/or changing, one or more characteristics of an antenna element, e.g., each antenna element, of the antenna array, e.g., as described below.

In some demonstrative aspects, a device implementing an antenna array, for example, a radar device, e.g., as described above with reference to FIGS. 1-9, may be configured to implement one or more operations and/or functionalities of a radiation-pattern control mechanism, which may be configured to provide a technical solution to support controlling, e.g., dynamically controlling, a beam-width and/or a steering angle of an antenna element, e.g., a single antenna element and/or each antenna element, of the antenna array, e.g., as described below.

In some demonstrative aspects, a device implementing an antenna array, for example, a radar device, e.g., as described above with reference to FIGS. 1-9, may be configured to implement a configurable-radiation-pattern antenna-element architecture, which may be configured to provide a technical solution to support controlling, e.g., dynamically controlling, one or more properties of one or more antenna elements of the antenna array, e.g., as described below.

In some demonstrative aspects, a device implementing an antenna array, for example, a radar device, e.g., as described above with reference to FIGS. 1-9, may be configured to implement a configurable-radiation-pattern antenna-element architecture for an antenna element, e.g., for each antenna element, of the antenna array, for example, to provide a technical solution to support controlling, e.g., dynamically controlling, one or more properties of the antenna element, e.g., each antenna element, of the antenna array, e.g., as described below.

In some demonstrative aspects, a device implementing an antenna array, for example, a radar device, e.g., as described above with reference to FIGS. 1-9, may be configured to implement a configurable-radiation-pattern antenna-element architecture, which may be configured to provide a technical solution to support controlling, e.g., dynamically controlling, one or more properties of antenna elements of the antenna array according to a phased-array antenna scheme, e.g., as described below.

In some demonstrative aspects, a device implementing an antenna array, for example, a radar device, e.g., as described above with reference to FIGS. 1-9, may be configured to implement a configurable-radiation-pattern antenna-element architecture, for example, as part of, or in the form of, a multiple-amplifier RF frontend, e.g., as described below.

In some demonstrative aspects, the multiple-amplifier RF frontend may be based on a frontend, e.g., an improved frontend, which may be configured to include a plurality of amplifiers, e.g., as described below.

In one example, the multiple-amplifier RF frontend may be implemented according to a multiple Power Amplifier (PA) architecture, for example, in case the multiple-amplifier RF frontend is implemented as part of a transmitter frontend, e.g., as described below.

In another example, the multiple-amplifier RF frontend may be implemented according to a multiple Low Noise Amplifier (LNA) architecture, for example, in case the multiple-amplifier RF frontend is implemented as part of a receiver frontend, e.g., as described below.

In some demonstrative aspects, the configurable-radiation-pattern antenna-element architecture may be configured to provide a technical solution to support controlling, e.g., dynamically controlling, a radiation pattern of an antenna element, e.g., each antenna element, in an antenna array, e.g., as described below.

In some demonstrative aspects, the configurable-radiation-pattern antenna-element architecture may be configured to provide a technical solution to support a configurable element-radiation-pattern of an antenna element, for example, for an antenna array of a phased array radar, e.g., as described below.

In some demonstrative aspects, the configurable radiation-pattern antenna element architecture may be implemented to provide a technical solution to support controlling, e.g., adaptively controlling, a radiation pattern, e.g., a beam-width and/or a steering angle, of an antenna element, e.g., each antenna element, of the antenna array, e.g., as described below.

In some demonstrative aspects, this ability to adaptively control the radiation pattern of the antenna element, e.g., of each antenna element, may be implemented to provide a technical solution to support improved radar performance of an antenna array, e.g., an improved SNR, an improved Equivalent Isotropically Radiated Power (EIRP), and/or an interference rejection of the antenna array, e.g., as described below.

In some demonstrative aspects, the configurable-radiation-pattern antenna-element architecture may be implemented by a multiple-port antenna element, which may be configured to provide the configurable element-radiation-pattern, e.g., as described below.

In some demonstrative aspects, the configurable-radiation-pattern antenna-element architecture may be configured to provide a technical solution to support the configurable element-radiation-pattern of the antenna element, for example, by controlling a power for a port, e.g., for each port, of the multiple-port antenna element, e.g., as described below.

In some demonstrative aspects, the multiple-port antenna element may include two or more separate antenna ports, e.g., as described below.

In some demonstrative aspects, a port, e.g., each port, of the multiple-port antenna element, may be connected to its own amplifier, e.g., as described below.

In some demonstrative aspects, outputs or inputs of substantially all amplifiers of the same multiple-port antenna element may be connected to two or more different antenna ports of the same multiple-port antenna element, e.g., as described below.

In some demonstrative aspects, the outputs or inputs of substantially all amplifiers of the same multiple-port antenna element may be combined, for example, using a phase shifter or a phase rotator, e.g., as described below.

In some demonstrative aspects, the outputs or inputs of substantially all amplifiers of the same multiple-port antenna element may be connected to two or more different antenna ports of the same multiple-port antenna element, for example, to provide a technical solution to control a radiation pattern of the multiple-port antenna element, e.g., as described below.

In some demonstrative aspects, the outputs or the inputs of substantially all the amplifiers of the same multiple-port antenna element may be combined coherently, for example, according to a desired radiation pattern shaping, e.g., as described below.

In some demonstrative aspects, the configurable radiation-pattern antenna-element architecture may be implemented to provide a technical solution to support shaping a radiation pattern of an antenna element of an antenna array, e.g., each antenna element of the antenna array, for example, to control, e.g., dynamically control, a Field of View (FoV) of the antenna array, e.g., as described below.

In some demonstrative aspects, the configurable radiation-pattern antenna-element architecture may be implemented to provide a technical solution to support controlling e.g., dynamically controlling, the FoV of the antenna array, for example, to improve an SNR and/or an EIRP of a radar system implementing the antenna array, e.g., as described below.

In some demonstrative aspects, the configurable radiation-pattern antenna-element architecture may be implemented to provide a technical solution to support enhanced steering of a radar beam to a specific angle, e.g., as described below.

In some demonstrative aspects, the configurable radiation-pattern antenna-element architecture may be implemented to provide a technical solution to support mitigation, e.g., avoidance, of strong interference, which may compress a receiver, e.g., each receiver, of a MIMO radar, e.g., as described below.

In some demonstrative aspects, the configurable radiation-pattern antenna-element architecture may be implemented to provide a technical solution to support mitigation, e.g., avoidance, of the strong interference, for example, by steering an element-beam of an antenna element, for example, away from the interference, e.g., as described below.

In some demonstrative aspects, the configurable radiation-pattern antenna-element architecture may be implemented to provide a technical solution to support a low cost and/or a flexible implementation of an antenna array, for example, for a multimodal system, to control a radiation pattern of an antenna element of the antenna array, e.g., as described below.

In some demonstrative aspects, the configurable radiation-pattern antenna-element architecture may be implemented to provide a technical solution to support adaptive control of the radiation pattern of the antenna element of the antenna array, e.g., as described below.

In some demonstrative aspects, the configurable radiation-pattern antenna-element architecture may be implemented to provide a technical solution to support a very wide beam-width of the antenna element, e.g., as described below.

For example, the very wide beam-width of the antenna element may cover substantially most of the half hemisphere in front of the antenna array.

In some demonstrative aspects, the configurable radiation-pattern antenna-element architecture may be implemented to provide a technical solution to support a narrow beam-width of the antenna element, e.g., as described below.

For example, the narrow beam-width of the antenna element may focus on a specific section in the half hemisphere in front of the antenna array. For example, the narrow beam-width of the antenna element may be implemented to support scanning and/or beam steering of the narrow beam-width within the specific section in the half hemisphere.

In some demonstrative aspects, the configurable radiation-pattern antenna-element architecture may be implemented to provide a technical solution to support steering the narrow beam-width of the antenna element to a section, which may not be in a normal direction of the antenna array, e.g., as described below.

For example, the narrow beam-width of the antenna element may be steered to directions other than the normal direction of the antenna array, e.g., up to a certain level.

According to this example, the configurable radiation-pattern antenna-element architecture may be implemented to provide a technical solution to support setting a peak of a radiation pattern of the antenna element, which may set the FoV of the antenna array, for example, to a specific degree above the horizon. For example, this setting may be implemented to support scanning an environment above the horizon. For example, this setting may provide a technical solution to improve an overall directivity and/or gain of the antenna array.

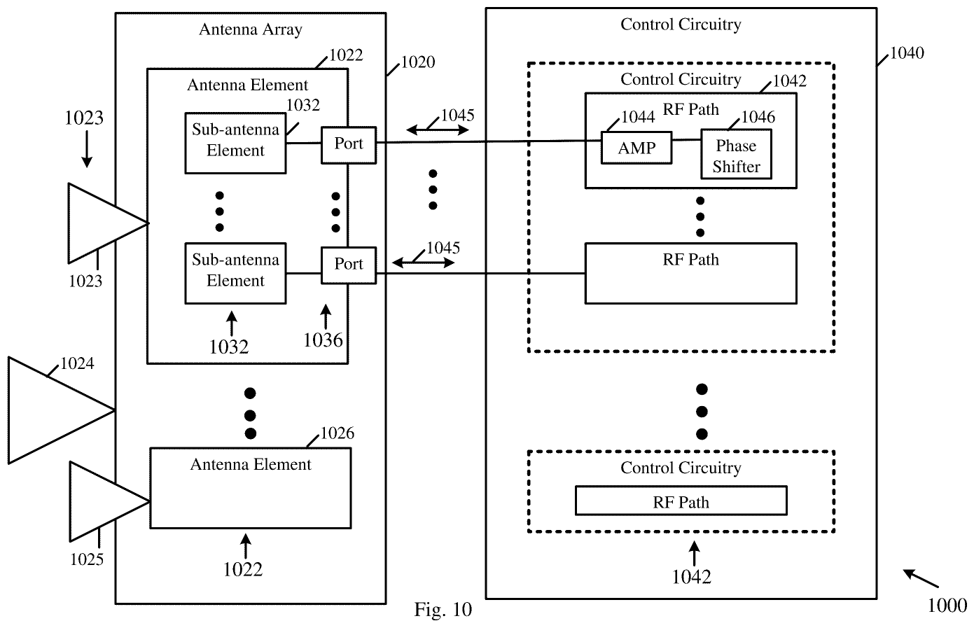

Reference is made to FIG. 10, which schematically illustrates a system 1000, in accordance with some demonstrative aspects.

In some demonstrative aspects, one or more components of system 1000 may be implemented as part of a radar device. For example, radar device 800 (FIG. 8) may include one or more element of system 1000, and/or may perform one or more operations and/or functionalities of system 1000.

In some demonstrative aspects, system 1000 may be implemented as part of any other suitable device and/or system.

For example, in some demonstrative aspects, system 1000 may be implemented as part of a device, for example, a mobile device, a computing device, and/or a wireless communication device, for example, to communicate RF wireless communication signals.

For example, in some demonstrative aspects, system 1000 may be implemented to communicate the RF wireless communication signals over millimeter wave (mmWave) frequencies and/or any other suitable frequencies.

In some demonstrative aspects, system 1000 may include an antenna array 1020 including a plurality of configurable-radiation-pattern antenna elements 1022, e.g., as described below.

In some demonstrative aspects, a configurable-radiation-pattern antenna element 1022 of the plurality of configurable-radiation-pattern antenna elements 1022 may have a configurable element-radiation-pattern 1023, e.g., as described below.

In some demonstrative aspects, system 1000 may include control circuitry 1040, which may be configured to control an array-radiation-pattern 1024 of the antenna array 1020, for example, according to an array-radiation-pattern setting, e.g., as described below.

In some demonstrative aspects, control circuitry 1040 may be configured to control the array-radiation-pattern 1024 of the antenna array 1020, for example, according to the array-radiation-pattern setting, for example, by configuring a plurality of element-radiation-patterns 1023 for the plurality of configurable-radiation-pattern antenna elements 1022, for example, based on the array-radiation-pattern setting, e.g., as described below.

In some demonstrative aspects, control circuitry 1040 may be configured to configure the plurality of element-radiation-patterns 1023 for the plurality of configurable-radiation-pattern antenna elements 122, for example, such that the array-radiation-pattern 1024 of the antenna array 1020 may be formed by a combination of the plurality of element-radiation-patterns 1023, e.g., as described below.

In some demonstrative aspects, the array-radiation-pattern setting may include a width setting of a width of the array-radiation-pattern 1024, e.g., as described below.

In some demonstrative aspects, the array-radiation-pattern setting may include a steering angle setting of a steering angle of the array-radiation-pattern 1024, e.g., as described below.

In other aspects, the array-radiation-pattern setting may include any other additional and/or alternative setting of the array-radiation-pattern 1024.

In some demonstrative aspects, control circuitry 1040 may be configured to control a steering angle of the configurable element-radiation-pattern 1023 of the configurable-radiation-pattern antenna element 1022, for example, based on the array-radiation-pattern setting of the array-radiation-pattern 1024, e.g., as described below.

In one example, control circuitry 1040 may be configured to control the steering angle of the configurable element-radiation-pattern 1023 of the configurable-radiation-pattern antenna element 1022, for example, based on the steering angle setting of the steering angle of the array-radiation-pattern 1024.

In some demonstrative aspects, control circuitry 1040 may be configured to control a width of the configurable element-radiation-pattern 1023 of the configurable-radiation-pattern antenna element 1022, for example, based on the array-radiation-pattern setting of the array-radiation-pattern 1024, e.g., as described below.

In one example, control circuitry 1040 may be configured to control the width of the configurable element-radiation-pattern 1023 of the configurable-radiation-pattern antenna element 1022, for example, based on the width setting of the width of the array-radiation-pattern 1024.

In some demonstrative aspects, a width of the configurable-radiation-pattern antenna element 1022 may be more than half of a wavelength of an RF signal, which is to be communicated via the configurable-radiation-pattern antenna element 1022, e.g., as described below.

In some demonstrative aspects, control circuitry 1040 may be configured to configure a first plurality of element-radiation-patterns 1023 for the plurality of configurable-radiation-pattern antenna elements 1022, for example, based on a first array-radiation-pattern setting, e.g., as described below.

In some demonstrative aspects, control circuitry 1040 may be configured to configure a second plurality of element-radiation-patterns 1023 for the plurality of configurable-radiation-pattern antenna elements 1022, for example, based on a second array-radiation-pattern setting, e.g., as described below.

In some demonstrative aspects, the second array-radiation-pattern setting may be different from the first array-radiation-pattern setting, e.g., as described below.

In some demonstrative aspects, the second plurality of element-radiation-patterns 1023 may be different from the first plurality of element-radiation-patterns 1023, e.g., as described below.

In some demonstrative aspects, control circuitry 1040 may be configured to configure a same element-radiation-pattern 1023 for two or more configurable-radiation-pattern antenna elements 1022 of the plurality of configurable-radiation-pattern antenna elements 1022, for example, based on the array-radiation-pattern setting of the array-radiation-pattern 1024, e.g., as described below.

In some demonstrative aspects, control circuitry 1040 may be configured to configure two different element-radiation-patterns 1023 for two or more configurable-radiation-pattern antenna elements 1022 of the plurality of configurable-radiation-pattern antenna elements 1022, for example, based on the array-radiation-pattern setting of the array-radiation-pattern 1024, e.g., as described below.

In some demonstrative aspects, control circuitry 1040 may be configured to configure a first element-radiation-pattern 1023 for a first configurable-radiation-pattern antenna element 1022 of the plurality of configurable-radiation-pattern antenna elements 1022, for example, based on the array-radiation-pattern setting of the array-radiation-pattern 1024, e.g., as described below.

In some demonstrative aspects, control circuitry 1040 may be configured to configure a second element-radiation-pattern 1025 for a second configurable-radiation-pattern antenna element 1026 of the plurality of configurable-radiation-pattern antenna elements 1022, for example, based on the array-radiation-pattern setting of the array-radiation-pattern 1024, e.g., as described below.

In some demonstrative aspects, the first element-radiation-pattern 1023 may be different from the second element-radiation-pattern 1025, e.g., as described below.

In some demonstrative aspects, the configurable-radiation-pattern antenna element 1022 may include a plurality of sub-antenna elements 1032, e.g., as described below.

In some demonstrative aspects, the configurable-radiation-pattern antenna element 1022 may include a plurality of ports 1036, which may be configured to connect the plurality of sub-antenna elements 1032 to the control circuitry 1040, e.g., as described below.

In some demonstrative aspects, control circuitry 1040 may be configured to control the configurable element-radiation-pattern 1023 of the configurable-radiation-pattern antenna element 1022, for example, according to an element-radiation-pattern setting for the configurable-radiation-pattern antenna element 1022, e.g., as described below.

In some demonstrative aspects, control circuitry 1040 may be configured to control the configurable element-radiation-pattern 1023 of the configurable-radiation-pattern antenna element 1022 according to the element-radiation-pattern setting for the configurable-radiation-pattern antenna element 1022, for example, by configuring a sub-element setting for the plurality of sub-antenna elements 1032, for example, based on the element-radiation-pattern setting for the configurable-radiation-pattern antenna element 1022, e.g., as described below.

In some demonstrative aspects, the element-radiation-pattern setting for the configurable-radiation-pattern antenna element 1022 may include a beam-width setting of a beam-width of the configurable element-radiation-pattern 1023, e.g., as described below.

In some demonstrative aspects, the element-radiation-pattern setting for the configurable-radiation-pattern antenna element 1022 may include a beam-gain setting of a beam-gain of the configurable element-radiation-pattern 1023, e.g., as described below.

In some demonstrative aspects, the element-radiation-pattern setting for the configurable-radiation-pattern antenna element 1022 may include a steering angle setting of a steering angle of the configurable element-radiation-pattern 1023, e.g., as described below.

In other aspects, the element-radiation-pattern setting for the configurable-radiation-pattern antenna element 1022 may include any other additional and/or alternative setting of the configurable element-radiation-pattern 1023.

In some demonstrative aspects, the sub-element setting for the plurality of sub-antenna elements 1032 may include a setting for RF signals 1045 communicated via the plurality of sub-antenna elements 1032, e.g., as described below.

In some demonstrative aspects, the sub-element setting for the plurality of sub-antenna elements 1032 may include a phase setting for the plurality of sub-antenna elements 1032, e.g., as described below.

In some demonstrative aspects, the phase setting for the plurality of sub-antenna elements 1032 may include phases to be applied between RF signals 1045 communicated via the plurality of sub-antenna elements 1032, e.g., as described below.

In some demonstrative aspects, control circuitry 1040 may be configured to control a first phase setting for the plurality of sub-antenna elements 1032, e.g., as described below.

In some demonstrative aspects, the first phase setting may include first phases to be applied between the RF signals 1045 communicated via the plurality of sub-antenna elements 1032, e.g., as described below.

In some demonstrative aspects, control circuitry 1040 may be configured to control a second phase setting for the plurality of sub-antenna elements 1032, e.g., as described below.

In some demonstrative aspects, the second phase setting may include second phases to be applied between the RF signals 1045 communicated via the plurality of sub-antenna elements 1032, e.g., as described below.

In some demonstrative aspects, the second phase setting may be different from the first phase setting, e.g., as described below.

In some demonstrative aspects, control circuitry 1040 may be configured to configure the first phase setting, for example, based on a first steering angle corresponding to a first element-radiation-pattern setting for the configurable-radiation-pattern antenna element 1022, e.g., as described below.

In some demonstrative aspects, control circuitry 1040 may be configured to configure the second phase setting, for example, based on a second steering angle corresponding to a second element-radiation-pattern setting for the configurable-radiation-pattern antenna element 1022, e.g., as described below.

In some demonstrative aspects, the second steering angle may be different from the first steering angle, e.g., as described below.

In some demonstrative aspects, the sub-element setting for the plurality of sub-antenna elements 1032 may include a sub-element count setting, e.g., as described below.

In some demonstrative aspects, the sub-element count setting may include a count of active sub-antenna elements 1032 of the plurality of sub-antenna elements 1032 to communicate the RF signals 1045, e.g., as described below.

In some demonstrative aspects, control circuitry 1040 may be configured to control a first sub-element count setting including a first count of active sub-antenna elements 1032, for example, based on a first element-radiation-pattern setting for the configurable-radiation-pattern antenna element 1022, e.g., as described below.

In some demonstrative aspects, control circuitry 1040 may be configured to control a second sub-element count setting including a second count of active sub-antenna elements 1032, for example, based on a second element-radiation-pattern setting for the configurable-radiation-pattern antenna element 1022, e.g., as described below.

In some demonstrative aspects, the second element-radiation-pattern setting for the configurable-radiation-pattern antenna element 1022 may be different from the first element-radiation-pattern setting, e.g., as described below.

In some demonstrative aspects, the second count of active sub-antenna elements may be different from the first count of active sub-antenna elements, e.g., as described below.

In some demonstrative aspects, control circuitry 1040 may be configured to configure the first sub-element count setting, for example, based on a first beam-width corresponding to a first element-radiation-pattern setting for the configurable-radiation-pattern antenna element 1022, e.g., as described below.

In some demonstrative aspects, control circuitry 1040 may be configured to configure the second sub-element count setting, for example, based on a second beam-width corresponding to a second element-radiation-pattern setting for the configurable-radiation-pattern antenna element 1022, e.g., as described below.

In some demonstrative aspects, the second beam-width may be different from the first beam-width, e.g., as described below.

In some demonstrative aspects, the first beam-width may be wider than the second beam-width, e.g., as described below.

In some demonstrative aspects, the first count of active sub-antenna elements may be less than the second count of active sub-antenna elements, for example, when the first beam-width is wider than the second beam-width, e.g., as described below.

In some demonstrative aspects, control circuitry 1040 may be configured to configure the first sub-element count setting, for example, based on a first beam-gain corresponding to a first element-radiation-pattern setting for the configurable-radiation-pattern antenna element 1022, e.g., as described below.

In some demonstrative aspects, control circuitry 1040 may be configured to configure the second sub-element count setting, for example, based on a second beam-gain corresponding to a second element-radiation-pattern setting for the configurable-radiation-pattern antenna element 1022, e.g., as described below.

In some demonstrative aspects, the second beam-gain may be different from the first beam-gain, e.g., as described below.

In some demonstrative aspects, the second beam-gain may be greater than the first beam-gain, e.g., as described below.

In some demonstrative aspects, the second count of active sub-antenna elements may be greater than the first count of active sub-antenna elements, for example, when the second beam-gain is greater than the first beam-gain, e.g., as described below.

In other aspects, any other suitable additional or alternative sub-element count settings may be implemented, for example, based on any other suitable criteria and/or any other additional or alternative attribute corresponding to the element-radiation-pattern setting for the configurable-radiation-pattern antenna element 1022.

In some demonstrative aspects, the first count of active sub-antenna elements may be one, e.g., as described below.

In other aspects, any other first count of active sub-antenna elements may be implemented.

In some demonstrative aspects, the second count of active sub-antenna elements may be greater than one, e.g., as described below.

In other aspects, any other second count of active sub-antenna elements may be implemented.

In some demonstrative aspects, the sub-element setting for the plurality of sub-antenna elements 1032 may include a sub-element gain setting for the plurality of sub-antenna elements 1032, e.g., as described below.

In some demonstrative aspects, the sub-element gain setting may include a plurality of gains to be applied to RF signals 1045 communicated via the plurality of sub-antenna elements 1032, e.g., as described below.

In some demonstrative aspects, the plurality of gains may include a first gain to be applied with respect to a first sub-antenna element of the plurality of sub-antenna elements 1032, e.g., as described below.

In some demonstrative aspects, the plurality of gains may include a second gain to be applied with respect to a second sub-antenna element of the plurality of sub-antenna elements 1032, e.g., as described below.

In some demonstrative aspects, the second gain may be different from the first gain, e.g., as described below.

In some demonstrative aspects, the second gain may be substantially equal to the first gain, e.g., as described below.

In some demonstrative aspects, the plurality of gains may include a third gain to be applied with respect to a third sub-antenna element of the plurality of sub-antenna elements 1032, e.g., as described below.

In some demonstrative aspects, the third gain may be different from the first gain, e.g., as described below.

In some demonstrative aspects, the third gain may be different from the second gain, e.g., as described below.

In some demonstrative aspects, the third gain may be substantially equal to the first gain and/or the second gain, e.g., as described below.

In some demonstrative aspects, the control circuitry 1040 may be configured to control a first sub-element gain setting for the plurality of sub-antenna elements 1032, for example, based on a first element-radiation-pattern setting for the configurable-radiation-pattern antenna element 1022, e.g., as described below.

In some demonstrative aspects, the control circuitry 1040 may be configured to control a second sub-element gain setting for the plurality of sub-antenna elements 1032, for example, based on a second element-radiation-pattern setting for the configurable-radiation-pattern antenna element 1022, e.g., as described below.

In some demonstrative aspects, the second element-radiation-pattern setting may be different from the first element-radiation-pattern setting, e.g., as described below.

In some demonstrative aspects, the second sub-element gain setting may be different from the first sub-element gain setting, e.g., as described below.

In other aspects, the sub-element setting for the plurality of sub-antenna elements 1032 may include any other additional and/or alternative setting.

In some demonstrative aspects, control circuitry 1040 may include, or may be implemented using, a plurality of RF paths 1042, e.g., as described below.

In some demonstrative aspects, the plurality of RF paths 1042 may be connected to the plurality of ports 1036 of the configurable-radiation-pattern antenna elements 1022, e.g., as described below.

In some demonstrative aspects, the plurality of RF paths 1042 may be configured to process the RF signals 1045, which may be communicated via the plurality of ports 1036, e.g., as described below.

In some demonstrative aspects, at least one RF path 1042 of the plurality of RF paths 1042 may include at least one amplifier 1044, e.g., as described below.

In some demonstrative aspects, control circuitry 1040 may be configured to control a gain of the amplifier 1044 of an RF path 1042 corresponding to configurable-radiation-pattern antenna element 1022, for example, based on the element-radiation-pattern setting for the configurable-radiation-pattern antenna element 1022, e.g., as described below.

In some demonstrative aspects, the at least one RF path 1042 of the plurality of RF paths 1042 may include at least one phase shifter 1046, e.g., as described below.

In some demonstrative aspects, control circuitry 1040 may be configured to set a phase shift to be applied by the phase shifter 1046 to an RF signal 1045 via the at least one RF path 1042, e.g., as described below.

In some demonstrative aspects, configurable-radiation-pattern antenna element 1022 may be configured to provide a technical solution to support different configurations of the antenna element, for example, in opposed to a standard antenna-element of a digital phased array radar antenna.

In some demonstrative aspects, configurable-radiation-pattern antenna element 1022 may include at least two ports 1036.

In some demonstrative aspects, a port 1036, e.g., each port 1036 of the at least two ports 1036, may be connected to a different sub-antenna element 1032, e.g., a “sub-element” or a “radiating-part”, of configurable-radiation-pattern antenna element 1022.

In some demonstrative aspects, control circuitry 1040 may be configured to control a sub-antenna element 1032 of configurable-radiation-pattern antenna element 1022 to operate in a stand-alone mode, e.g., while other sub-antenna elements 1032 of configurable-radiation-pattern antenna element 1022 remain inactive.

In some demonstrative aspects, control circuitry 1040 may be configured to control a sub-antenna element 1032 to operate in combination with one or more other sub-antenna elements 1032 of configurable-radiation-pattern antenna element 1022. For example, control circuitry 1040 may be configured to coherently combine the sub-antenna element 1032 with the other sub-antenna elements 1032 of configurable-radiation-pattern antenna element 1022.

In some demonstrative aspects, a sub-antenna element 1032, e.g., each sub-antenna element 1032, may be configured as a matched antenna.

In some demonstrative aspects, a total physical area of a configurable-radiation-pattern antenna element 1022, e.g., including all its radiating-parts, may be small enough, for example, to provide a technical solution to support implementing an array of configurable-radiation-pattern antenna elements 1022 in an appropriate spacing, for example, for beam steering.

In some demonstrative aspects, control circuitry 1040 may be configured to activate only one sub-antenna element 1032 of configurable-radiation-pattern antenna element 1022, for example, to provide a technical solution to support a wide beam-width pattern for configurable-radiation-pattern antenna element 1022.

In some demonstrative aspects, control circuitry 1040 may be configured to activate two or more sub-antenna elements 1032 of configurable-radiation-pattern antenna element 1022, for example, to provide a technical solution to support a narrow beam-width pattern for configurable-radiation-pattern antenna element 1022.

In some demonstrative aspects, control circuitry 1040 may be configured to apply a phase offset between sub-antenna elements 1032 of configurable-radiation-pattern antenna element 1022, for example, to provide a technical solution to support beam steering capabilities for configurable-radiation-pattern antenna element 1022.

In some demonstrative aspects, control circuitry 1040 may be configured to support the wide beam-width pattern, the narrow beam-width pattern, and/or the beam steering capabilities for configurable-radiation-pattern antenna element 1022, for example, even in case of a relatively “moderate” mutual coupling between the sub-antenna elements 1032 of configurable-radiation-pattern antenna element 1022, which may still support a substantially “standalone” operation of each sub-antenna element 1032.

In some demonstrative aspects, a Tx array, e.g., a Tx array 824 (FIG. 8), may include antenna array 1020. For example, antenna array 1020 may be implemented as part of a transmitter frontend, e.g., transmitter 883 (FIG. 8).

In one example, control circuitry 1040 may include a multiple PA architecture, for example, when antenna array 1020 is implemented as part of a transmitter frontend, e.g., as described below.

In some demonstrative aspects, an Rx array, e.g., an Rx array 826 (FIG. 8), may include antenna array 1020. For example, antenna array 1020 may be implemented as part of a receiver frontend, e.g., receiver 885 (FIG. 8).

In another example, control circuitry 1040 may include a multiple LNA architecture, for example, when antenna array 1020 is implemented as part of a receiver frontend, e.g., as described below.

In some demonstrative aspects, control circuitry 1040 may include a plurality of power combiners for the plurality of configurable-radiation-pattern antenna element 1022, for example, when antenna array 1020 implemented as part of a receiver frontend, e.g., as described below.

In some demonstrative aspects, control circuitry 1040 may include a plurality of power splitters for the plurality of configurable-radiation-pattern antenna element 1022, for example, when antenna array 1020 implemented as part of a transmitter frontend, e.g., as described below.

In some demonstrative aspects, the plurality of power combiners and/or the plurality of power splitters may be implemented, for example, in addition to time delay elements and/or phase shifters, e.g., phase shifters 1046.

In one example, phase shifters may be implemented, for example, instead of time delay elements, for example, for relatively low bandwidth implementations, e.g., for implementations configured for about 10% of a carrier frequency and below.

In some demonstrative aspects, control circuitry 1040 may include a power splitter or a power combiner, at least one phase shifter, e.g., phase shifter 1046, and/or at least one amplifier, e.g., amplifier 1044, for a configurable-radiation-pattern antenna element 1022, for example, to provide a technical solution to controllably support a wide beam-width pattern, a narrow beam-width pattern, and/or beam steering capabilities for configurable-radiation-pattern antenna element 1022.

In some demonstrative aspects, the at least one amplifier may be positioned relatively close to the plurality of ports 1036 of configurable-radiation-pattern antenna element 1022, for example, before the phase shifter, and/or the power splitter or the power combiner, for example, to provide a technical solution to avoid losses, which may result from the phase shifter, the power splitter and/or the power combiner.

In some demonstrative aspects, system 1000 may be configured to provide a technical solution to support systems, which utilize a phased antenna array. For example, system 1000 may be implemented to support RF communications performed by radar applications, localization applications, satellite applications, communication applications, drone applications, and/or the like.

In some demonstrative aspects, system 1000 may be configured to provide a technical solution to enhance performance of a system implementing communication of RF signals, and/or to support a wider covered field of view, for example, even without substantially any performance and/or SNR degradation, e.g., while maintaining full flexibility.

In some demonstrative aspects, the configurable-radiation-pattern antenna element 1022 may include a multi-patch antenna element, e.g., as described below.

In some demonstrative aspects, the multi-patch antenna element may include a first antenna patch and a second antenna patch, e.g., as described below.

In some demonstrative aspects, the multi-patch antenna element may include a first port 1036 to connect the first antenna patch to the control circuitry 1040, and a second port 1036 to connect the second antenna patch to the control circuitry 1040, e.g., as described below.

In some demonstrative aspects, control circuitry 1040 may be configured to control the configurable element-radiation-pattern 1023 of the configurable-radiation-pattern antenna element 1022, for example, according to an element-radiation-pattern setting for the configurable-radiation-pattern antenna element 1022, for example, by configuring a setting for the first antenna patch and the second antenna patch, for example, based on the element-radiation-pattern setting for the configurable-radiation-pattern antenna element 1022, e.g., as described below.

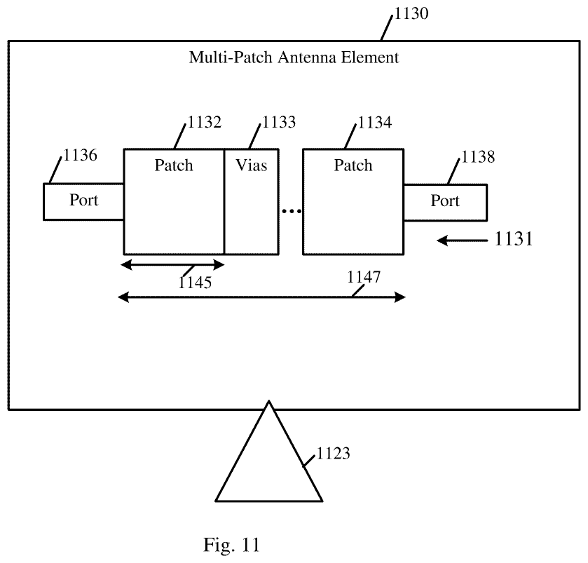

Reference is made to FIG. 11, which schematically illustrates a multi-patch antenna element 1130, in accordance with some demonstrative aspects. For example, configurable-radiation-pattern antenna element 1022 (FIG. 10) may include one or more elements of multi-patch antenna element 1130, and/or may perform one or more operations and/or functionalities of multi-patch antenna element 1130.

In some demonstrative aspects, as shown in FIG. 11, multi-patch antenna element 1130 may include a plurality of antenna patches 1131, e.g., as described below.

In some demonstrative aspects, as shown in FIG. 11, multi-patch antenna element 1130 may include a first antenna patch 1132, e.g., as described below.

In some demonstrative aspects, as shown in FIG. 11, multi-patch antenna element 1130 may include a second antenna patch 1134, e.g., as described below.

In some demonstrative aspects, as shown in FIG. 11, multi-patch antenna element 1130 may include a first port 1136, for example, to connect the first patch 1132 to control circuitry, e.g., control circuitry 1040 (FIG. 10), e.g., as described below.

In some demonstrative aspects, as shown in FIG. 11, multi-patch antenna element 1130 may include a second port 1138, for example, to connect the second patch 1134 to the control circuitry, e.g., control circuitry 1040 (FIG. 10), e.g., as described below.

In some demonstrative aspects, as shown in FIG. 11, multi-patch antenna element 1130 may have a configurable element-radiation-pattern 1123.

In some demonstrative aspects, the control circuitry, e.g., control circuitry 1040 (FIG. 10), may be configured to control the configurable element-radiation-pattern 1123 of the multi-patch antenna element 1130 according to an element-radiation-pattern setting for the multi-patch antenna element 1130, for example, by configuring a setting for the first antenna patch 1132 and the second antenna patch 1134, for example, based on the element-radiation-pattern setting for the multi-patch antenna element 1130.

In some demonstrative aspects, a width 1145 of each of the first antenna patch 1132 and the second antenna path 1134 may be no more than a quarter of a wavelength (24) of an RF signal communicated via the multi-patch antenna element 1130, e.g., as described below.

In some demonstrative aspects, a width 1147 of the multi-patch antenna element 1130 may be no more than half of a wavelength (2/2) of the RF signal communicated via the multi-patch antenna element 1130, e.g., as described below.

In some demonstrative aspects, as shown in FIG. 11, the first port 1136 may be on a first side of the multi-patch antenna element 1130, e.g., as described below.

In some demonstrative aspects, as shown in FIG. 11, the second port 1138 may be on a second side of the multi-patch antenna element 1130, for example, opposite to the first side, e.g., as described below.

In some demonstrative aspects, as shown in FIG. 11, the multi-patch antenna element 1130 may include a plurality of grounded vias 1133 between the first antenna patch 1132 and the second antenna patch 1134, e.g., as described below.

In some demonstrative aspects, the multi-patch antenna element 1130 may be configured to provide a technical solution to connect two or more antenna patches 1131 of the multi-patch antenna element 1130 to the control circuitry, e.g., control circuitry 1040 (FIG. 10), via two or more ports of the multi-patch antenna element 1130.

In some demonstrative aspects, multi-patch antenna element 1130 may include a dual-patch antenna element, e.g., as described below.

In some demonstrative aspects, the dual-patch antenna element may include two quarter wavelength patches attached together, for example, in a “back to back” configuration, e.g., as described below.

In some demonstrative aspects, the two quarter wavelength patches attached together in the “back to back” configuration may form a half wavelength antenna element, e.g., as described below.

In some demonstrative aspects, as shown in FIG. 11, the first antenna patch 1132 may include a first quarter wavelength patch, and the second antenna patch 1134 may include a second quarter wavelength patch. For example, the multi-patch antenna element 1130 may be configured such that the first quarter wavelength patch 1132 and the second quarter wavelength patch 1134 may share a same plurality of grounded vias 1133.

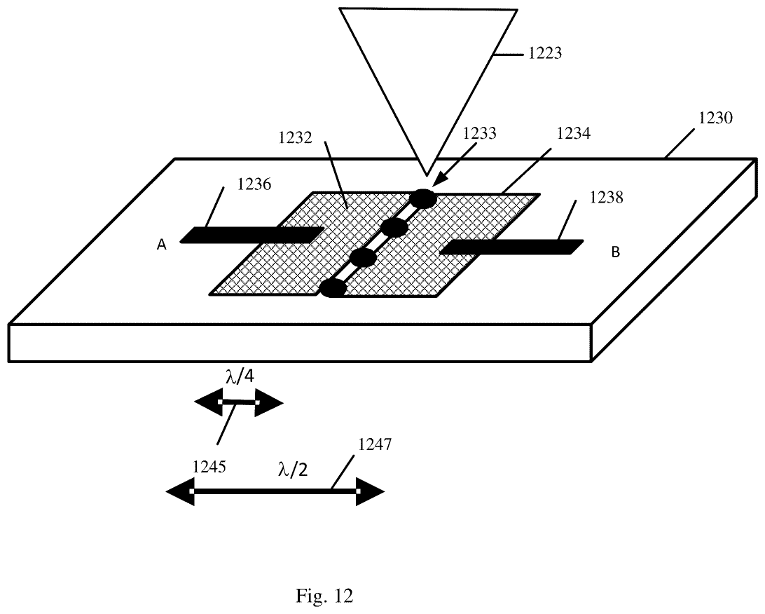

Reference is made to FIG. 12, which schematically illustrates a dual-patch antenna element 1230, in accordance with some demonstrative aspects. For example, configurable-radiation-pattern antenna element 1022 (FIG. 10) may include one or more elements of dual-patch antenna element 1230, and/or may perform one or more operations and/or functionalities of dual-patch antenna element 1230; and/or multi-patch antenna element 1130 (FIG. 11) may include one or more elements of dual-patch antenna element 1230, and/or may perform one or more operations and/or functionalities of dual-patch antenna element 1230.

In some demonstrative aspects, as shown in FIG. 12, dual-patch antenna element 1230 may include a first antenna patch 1232.

In some demonstrative aspects, as shown in FIG. 12, dual-patch antenna element 1230 may include a second antenna patch 1234.

In some demonstrative aspects, as shown in FIG. 12, dual-patch antenna element 1230 may include a first port 1236, for example, to connect the first patch 1232 to control circuitry, e.g., control circuitry 1040 (FIG. 10).

In some demonstrative aspects, as shown in FIG. 12, dual-patch antenna element 1230 may include a second port 1238, for example, to connect the second patch 1234 to the control circuitry, e.g., control circuitry 1040 (FIG. 10).

In some demonstrative aspects, as shown in FIG. 12, dual-patch antenna element 1230 may have a configurable element-radiation-pattern 1223.

In some demonstrative aspects, the control circuitry, e.g., control circuitry 1040 (FIG. 10), may be configured to control the configurable element-radiation-pattern 1223 of the dual-patch antenna element 1230 according to an element-radiation-pattern setting for the dual-patch antenna element 1230, for example, by configuring a setting for the first antenna patch 1232 and the second antenna patch 1234, for example, based on the element-radiation-pattern setting for the dual-patch antenna element 1230.

In some demonstrative aspects, as shown in FIG. 12, a width 1245 of each of the first antenna patch 1232 and the second antenna path 1234 may be no more than a quarter of a wavelength (24) of an RF signal, which is to be communicated via the dual-patch antenna element 1230.

In some demonstrative aspects, as shown in FIG. 12, a width 1247 of the dual-patch antenna element 1230 may be no more than half of a wavelength (2/2) of the RF signal, which is to be communicated via the dual-patch antenna element 1230.

In some demonstrative aspects, as shown in FIG. 12, the first port 1236 may be on a first side of the dual-patch antenna element 1230.

In some demonstrative aspects, as shown in FIG. 12, the second port 1238 may be on a second side of the dual-patch antenna element 1230, for example, opposite to the first side.

In some demonstrative aspects, as shown in FIG. 12, the dual-patch antenna element 1230 may include a plurality of grounded vias 1233 between the first antenna patch 1232 and the second antenna patch 1234.

In some demonstrative aspects, the dual-patch antenna element 1230 may be implemented to provide a technical solution to support operation of the dual-patch antenna element 1230 at a first mode, e.g., as a half-wavelength-patch antenna-element, e.g., similar to a standard half-wavelength-patch antenna-element.

In some demonstrative aspects, control circuitry, e.g., control circuitry 1040 (FIG. 10), may be configured to operate the dual-patch antenna element 1230 as a half-wavelength-patch antenna-element, for example, by feeding the dual-patch antenna element 1230 with a balanced feed, e.g., including two differential feeds via the first port 1236 and the second port 1238, respectively.

In some demonstrative aspects, the dual-patch antenna element 1230 may be implemented to provide a technical solution to support operation of the dual-patch antenna element 1230 at a second mode, e.g., as a single quarter-wavelength-patch antenna-element. For example, the single quarter-wavelength-patch antenna-element may be utilized to support a wider radiation of the dual-patch antenna element 1230, e.g., twice wider, compared to a radiation pattern of the half-wavelength-patch antenna-element. For example, a width of the radiation pattern of the single quarter-wavelength-patch antenna-element may cover a FoV greater than 140 degrees) (°.

In some demonstrative aspects, the control circuitry, e.g., control circuitry 1040 (FIG. 10), may be configured to operate the dual-patch antenna element 1230 as a single quarter-wavelength-patch antenna-element, for example, by feeding the dual-patch antenna element 1230 via a single port, via the first port 1236 or via the second port 1238.

In some demonstrative aspects, the dual-patch antenna element 1230 may be implemented to provide a technical solution to support operation of the dual-patch antenna element 1230 at a third mode, e.g., as two quarter-wavelength-patch antenna-elements operating together. For example, this mode may be utilized to provide a beam with a beam-width of a single half-wavelength-patch antenna element, while steering the beam. For example, the radiation pattern of the two quarter-wavelength-patch antenna-elements operating together may support a beam having a width covering a FoV greater than 140°, e.g., while steering the beam.

In some demonstrative aspects, the control circuitry, e.g., control circuitry 1040 (FIG. 10), may be configured to operate the dual-patch antenna element 1230 as the two quarter-wavelength-patch antenna-elements operating together, for example, by applying a phase shift between two RF signals communicated via the two antenna patches, respectively, of dual-patch antenna element 1230.

In some demonstrative aspects, the dual-patch antenna element 1230 may be implemented to provide a technical solution to support operation of two quarter-wavelength-patch antenna-elements together, for example, to provide a beam with a beam-width narrower than the beam-width of the single half-wavelength-patch antenna element, for example, while steering the beam. For example, a width of the radiation pattern of the two quarter-wavelength-patch antenna-elements operating together may cover a FoV narrower than 140°, while steering the beam in a FoV of 140°.

In some demonstrative aspects, the control circuitry, e.g., control circuitry 1040 (FIG. 10), may be configured to operate the dual-patch antenna element 1230 as the two quarter-wavelength-patch antenna-elements operating together, for example, to provide a technical solution to support a relatively narrow beam width, for example, by applying a phase offset of 180° between two RF signals communicated via the two antenna patches, respectively, of dual-patch antenna element 1230.

In some demonstrative aspects, the dual-patch antenna element 1230 may be implemented to provide a technical solution to support enhanced performance.

In some demonstrative aspects, the dual-patch antenna element 1230 may be implemented to provide a technical solution to support an increased coverage on substantially all FoVs, e.g., with substantially no grating lobes.

In some demonstrative aspects, the dual-patch antenna element 1230 may be implemented to provide a technical solution to support an antenna element of a phased array antenna.

For example, an overall size of the dual-patch antenna element 1230 may be no more than half of a wavelength of an RF signal to be communicated via dual-patch antenna element 1230. For example, the overall size of the dual-patch antenna element 1230 may be less than half of the wavelength of an RF signal to be communicated via dual-patch antenna element 1230, e.g., even in case each of the patch antennas 1232 and 1234 include quarter-wavelength-patch antenna elements, for example, due to a dielectric constant of a substrate, which may “shrink” a size of the patch antenna-element. According to this example, the dual-patch antenna element 1230 may easily fit into a half wavelength spacing phased array antenna, and may cover all the FoV of the phased array antenna, e.g., with no grating lobes.

In some demonstrative aspects, the dual-patch antenna element 1230 may be implemented with a gap between the two quarter-wavelength-patch antenna-elements 1232 and 1234, for example, to provide a technical solution to decrease a mutual coupling between the two quarter-wavelength-patch antenna-elements 1232 and 1234, and/or to improve an isolation between the two quarter-wavelength-patch antenna-elements 1232 and 1234. For example, this implementation may still maintain a half-wavelength spacing of the phased array antenna, e.g., due to the dielectric constant of the substrate.

In some demonstrative aspects, one or more, e.g., some or all, of the plurality of grounded vias 1233 may be shared by, or common to, the first antenna patch 1232 and the second antenna patch 1234. For example, as shown in FIG. 12, the first antenna patch 1232 and the second antenna patch 1234 may share the same common plurality of grounded vias 1233.

In some demonstrative aspects, the dual-patch antenna element 1230 may include one or more first grounded vias, e.g., first dedicated grounded vias, for the first antenna patch 1232, and/or one or more second grounded vias, e.g., second dedicated grounded vias, for the second antenna patch 1234.

For example, the dual-patch antenna element 1230 may include a first plurality of grounded vias, which may be configured to short an edge of the first antenna patch 1232, and a second plurality of grounded vias, which may be configured to short an edge of the second antenna patch 1234. For example, the first plurality of grounded vias and the second plurality of grounded vias may be implemented, for example, in an implementation of the dual-patch antenna element 1230 with the gap between the two quarter-wavelength-patch antenna-elements 1232 and 1234.

In some demonstrative aspects, the dual-patch antenna element 1230 may be implemented to provide a technical solution to support a controllable beam-width, e.g., which may be controllably set to a first beam-width and a second beam-width, which is wider than the first beam-width.

In some demonstrative aspects, the dual-patch antenna element 1230 may be implemented to provide a technical solution to support controllable steering of a beam of the dual-patch antenna element 1230, for example, to a first side or to a second side, which is opposite to the first side.

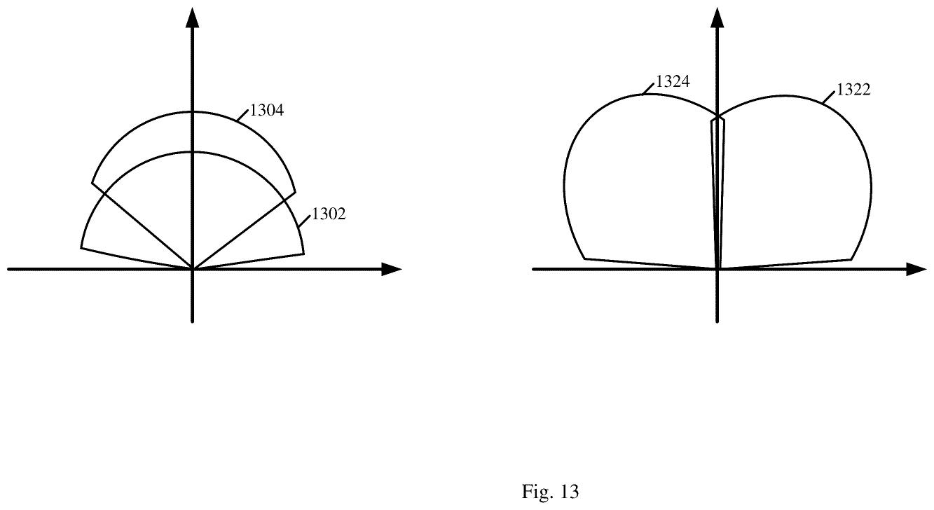

Reference is made to FIG. 13, which schematically illustrates radiation patterns of a dual-patch antenna element, in accordance with some demonstrative aspects.

In one example, dual-patch antenna element 1230 (FIG. 12) may be configured to provide one or more of the radiation patterns of FIG. 13.

In some demonstrative aspects, as shown in FIG. 13, the dual-patch antenna element may be controlled to generate a first radiation pattern 1302.

In some demonstrative aspects, control circuitry, e.g., control circuitry 1040 (FIG. 10), may be configured to control the dual-patch antenna element 1230 (FIG. 12) to provide the first radiation pattern 1302, for example, by operating only a single quarter-wavelength-patch antenna-element of the dual-patch antenna element 1230 (FIG. 12), e.g., first antenna patch 1232 (FIG. 12) or second antenna patch 1234 (FIG. 12).

In some demonstrative aspects, control circuitry, e.g., control circuitry 1040 (FIG. 10), may be configured to control the dual-patch antenna element 1230 to provide the first radiation pattern 1302, for example, to support an increased, e.g., a maximal FoV, for example, a FoV of at least 140°, which may even support difficult “grazing” angles, e.g., beyond ±70°, for example, with respect to a “forward looking” axis at 0°.

In some demonstrative aspects, as shown in FIG. 13, the dual-patch antenna element may be controlled to generate a second radiation pattern 1304.

In some demonstrative aspects, control circuitry, e.g., control circuitry 1040 (FIG. 10), may be configured to control the dual-patch antenna element 1230 (FIG. 12) to provide the second radiation pattern 1304, for example, by operating together two quarter-wavelength-patch antenna-elements of the dual-patch antenna element 1230 (FIG. 12), e.g., first antenna patch 1232 (FIG. 12) and second antenna patch 1234 (FIG. 12). For example, the first antenna patch 1232 (FIG. 12) and second antenna patch 1234 (FIG. 12) may be operated with a phase offset of 180° applied between two RF signals, which may be fed in different directions to the two quarter-wavelength-patch antenna-elements, respectively. For example, this phase offset of 180° may be configured to focus in a forward direction a beam formed by the two quarter-wavelength-patch antenna-elements.

In some demonstrative aspects, the control circuitry, e.g., control circuitry 1040 (FIG. 10), may be configured to control the dual-patch antenna element 1230 to provide the second radiation pattern 1304, for example, to support a relatively high directivity and/or gain, and/or an improved SNR, for example, when a maximal FoV is not required.

In some demonstrative aspects, as shown in FIG. 13, the dual-patch antenna element may be controlled to generate a third radiation pattern 1322.

In some demonstrative aspects, control circuitry, e.g., control circuitry 1040 (FIG. 10), may be configured to control the dual-patch antenna element 1230 (FIG. 12) to provide the third radiation pattern 1322, for example, by operating together two quarter-wavelength-patch antenna-elements of the dual-patch antenna element 1230 (FIG. 12), e.g., first antenna patch 1232 (FIG. 12) and second antenna patch 1234 (FIG. 12), with a positive phase offset applied between two RF signals communicated via the two quarter-wavelength-patch antenna-elements, respectively. For example, the positive phase offset applied between the two RF signals may be configured to form the third radiation pattern 1322, which may be tilted to the right. In one example, the positive phase offset may be applied between the two RF signals, for example, by applying a positive phase offset to first antenna patch 1232 (FIG. 12) and a zero phase offset to second antenna patch 1234 (FIG. 12). In another example, the positive phase offset may be applied between the two RF signals, for example, by applying a positive phase offset to second antenna patch 1234 (FIG. 12) and a zero phase offset to first antenna patch 1232 (FIG. 12).

In some demonstrative aspects, the control circuitry, e.g., control circuitry 1040 (FIG. 10), may be configured to control the dual-patch antenna element 1230 (FIG. 12) to provide the third radiation pattern 1322, for example, to support an improved coverage for a righthand side, for example, while rejecting possible interferences on a lefthand side and/or when the lefthand side is not relevant.

In some demonstrative aspects, as shown in FIG. 13, the dual-patch antenna element may be controlled to generate a fourth radiation pattern 1324.

In some demonstrative aspects, control circuitry, e.g., control circuitry 1040 (FIG. 10), may be configured to control the dual-patch antenna element 1230 (FIG. 12) to provide the fourth radiation pattern 1324, for example, by operating together two quarter-wavelength-patch antenna-elements of the dual-patch antenna element 1230 (FIG. 12), e.g., first antenna patch 1232 (FIG. 12) and second antenna patch 1234 (FIG. 12), with a negative phase offset, e.g., opposite to the positive phase offset, applied between the two RF signals communicated via the two quarter-wavelength-patch antenna-elements, respectively. In one example, the negative phase offset may include the same phase offset as the positive phase offset with a negative sign. For example, the negative phase offset applied between the two RF signals may be configured to form the fourth radiation pattern 1324, which may be tilted to the left. In one example, the negative phase offset may be applied between the two RF signals, for example, by applying a negative phase offset to first antenna patch 1232 (FIG. 12) and a zero phase offset to second antenna patch 1234 (FIG. 12). In another example, the negative phase offset may be applied between the two RF signals, for example, by applying a negative phase offset to second antenna patch 1234 (FIG. 12) and a zero phase offset to first antenna patch 1232 (FIG. 12).

In some demonstrative aspects, the control circuitry, e.g., control circuitry 1040 (FIG. 10), may be configured to control the dual-patch antenna element 1230 (FIG. 12) to provide the fourth radiation pattern 1324, for example, to support an improved coverage for the lefthand side, for example, while rejecting possible interferences on the righthand side, and/or when the righthand side is not relevant.

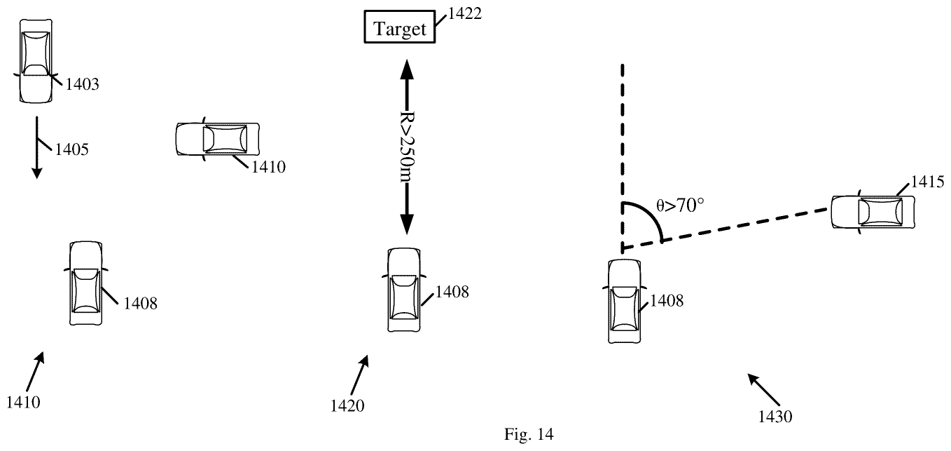

Reference is made to FIG. 14, which schematically illustrates radiation pattern adaptation scenarios, in accordance with some demonstrative aspects.

In some demonstrative aspects, a scenario 1410 may demonstrate an interferer radar signal 1405 from a vehicle 1403, which may cause interference to a front radar of a vehicle 1408, e.g., from a lefthand side of the vehicle 1408.

In some demonstrative aspects, control circuitry, e.g., control circuitry 1040 (FIG. 10), may be configured to control the front radar of vehicle 1408 to focus on targets on the righthand side of vehicle 1408, e.g., to detect a vehicle 1410, for example, by controlling the dual-patch antenna element 1230 (FIG. 12) to provide the radiation pattern 1322 (FIG. 13), which is tilted to the righthand side.

In some demonstrative aspects, a scenario 1420 may demonstrate a low Radar Cross Section (RCS) target 1422, e.g., a bicycle or the like, which may be located relatively far from the front radar of the vehicle 1408, e.g., at a distance greater than 250 meter from the front radar of vehicle 1408.

In some demonstrative aspects, control circuitry, e.g., control circuitry 1040 (FIG. 10), may be configured to control the front radar of vehicle 1408 to provide a radiation pattern with relatively high directivity to the front direction, for example, by controlling the dual-patch antenna element 1230 (FIG. 12) to provide the radiation pattern 1304 (FIG. 13), which is relatively narrow and directed to the front.

In some demonstrative aspects, a scenario 1430 may demonstrate a target 1415, which may be located at a grazing angle relative to the front radar of the vehicle 1408, e.g., a grazing angle of at least 70°.

In some demonstrative aspects, control circuitry, e.g., control circuitry 1040 (FIG. 10), may be configured to control the front radar of vehicle 1408 to provide a radiation pattern with a very wide beam-width, for example, to support detection of the target 1415, for example, by controlling the dual-patch antenna element 1230 (FIG. 12) to provide the radiation pattern 1302 (FIG. 13), which covers a FoV greater than 140°.

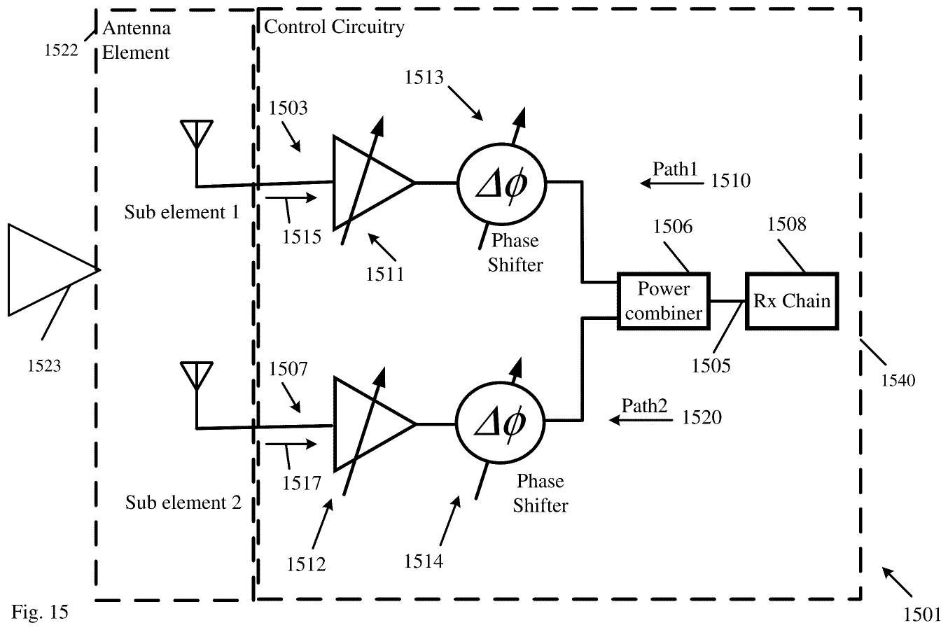

Reference is made to FIG. 15, which schematically illustrates Rx circuitry 1501 including Rx control circuitry 1540, in accordance with some demonstrative aspects.

For example, control circuitry 1040 (FIG. 10) may include one or more elements of Rx control circuitry 1540, and/or may perform one or more operations and/or functionalities of Rx control circuitry 1540.

In some demonstrative aspects, Rx control circuitry 1540 may be configured to control a configurable element-radiation-pattern 1523 of a configurable-radiation-pattern antenna element 1522, for example, according to an element-radiation-pattern setting for the configurable-radiation-pattern antenna element 1522.

In some demonstrative aspects, as shown in FIG. 15, configurable-radiation-pattern antenna element 1522 may include a first sub-antenna element (Sub element 1), and a second sub-antenna element (Sub element 2).

For example, configurable-radiation-pattern antenna element 1022 (FIG. 10) may include one or more elements of configurable-radiation-pattern antenna element 1522, and/or may perform one or more operations and/or functionalities of configurable-radiation-pattern antenna element 1522.

In some demonstrative aspects, as shown in FIG. 15, configurable-radiation-pattern antenna element 1522 may include a first port 1503 connecting the first sub-antenna element to Rx control circuitry 1540.

In some demonstrative aspects, as shown in FIG. 15, configurable-radiation-pattern antenna element 1522 may include a second port 1507 connecting the second sub-antenna element to Rx control circuitry 1540.

In some demonstrative aspects, as shown in FIG. 15, Rx control circuitry 1540 may include a first Rx path 1510, which may be configured to process a first Rx signal 1515 communicated via the first antenna port 1503.

In some demonstrative aspects, as shown in FIG. 15, Rx control circuitry 1540 may include a second Rx path 1520, which may be configured to process a second Rx signal 1517 communicated via the second antenna port 1507.

In some demonstrative aspects, as shown in FIG. 15, first Rx path 1510 may include a first LNA 1511, which may be configured to amplify the first Rx signal 1515.

In some demonstrative aspects, as shown in FIG. 15, first Rx path 1510 may include a first phase shifter 1513, which may be configured to apply a first phase shift to the first Rx signal 1515.

In some demonstrative aspects, as shown in FIG. 15, second Rx path 1520 may include a second LNA 1512, which may be configured to amplify the second Rx signal 1517.

In some demonstrative aspects, as shown in FIG. 15, second Rx path 1520 may include a second phase shifter 1514, which may be configured to apply a second phase shift to the second Rx signal 1517.

In some demonstrative aspects, as shown in FIG. 15, Rx control circuitry 1540 may include a power combiner 1506, which may be configured to combine the first Rx signal 1515 and the second Rx signal 1517 into an Rx signal 1505.

In some demonstrative aspects, as shown in FIG. 15, Rx control circuitry 1540 may include Rx chain circuitry 1508, which may be configured to process the Rx signal 1505.

In some demonstrative aspects, Rx control circuitry 1540 may be configured to control a gain of LNA 1511 and/or a gain of LNA 1512, for example, based on an element-radiation-pattern setting for the configurable-radiation-pattern antenna element 1522.

In some demonstrative aspects, Rx control circuitry 1540 may be configured to control phase shifter 1513 and/or phase shifter 1514, for example, to apply a phase offset between the first Rx signal 1515 in the first Rx path 1510 and the second Rx signal 1517 in the second Rx path 1520, for example, based on the element-radiation-pattern setting for the configurable-radiation-pattern antenna element 1522.

In some demonstrative aspects, each LNA of the LNAs of the Rx control circuitry 1540 may have a gain control, and/or each phase shifter of the phase shifters of the Rx control circuitry 1540 may have an offset control feature.

In other aspects, only one LNA of the LNAs of the Rx control circuitry 1540 may have a gain control, and/or only one phase shifter of the phase shifters of the Rx polarization control circuitry 1540 may have an offset control feature. For example, Rx control circuitry 1540 may include a single variable phase shifter, and/or a single gain-controlled LNA.

In some demonstrative aspects, as shown in FIG. 15, Rx control circuitry 1540 may include two Rx paths, which may be connected to two sub-antenna elements of the configurable-radiation-pattern antenna element 1522 via two ports of the configurable-radiation-pattern antenna element 1522.

In other aspects, Rx control circuitry 1502 may include more than two Rx paths, which may be connected to more than two sub-antenna elements of the configurable-radiation-pattern antenna element 1522 via more than two ports of the configurable-radiation-pattern antenna element 1522.

In some demonstrative aspects, Rx control circuitry 1502 may include at least one phase rotator, for example, instead of at least one phase shifter, e.g., phase shifter 1513 and/or phase shifter 1514, for example, to provide a technical solution to support phase offsets with an improved resolution.

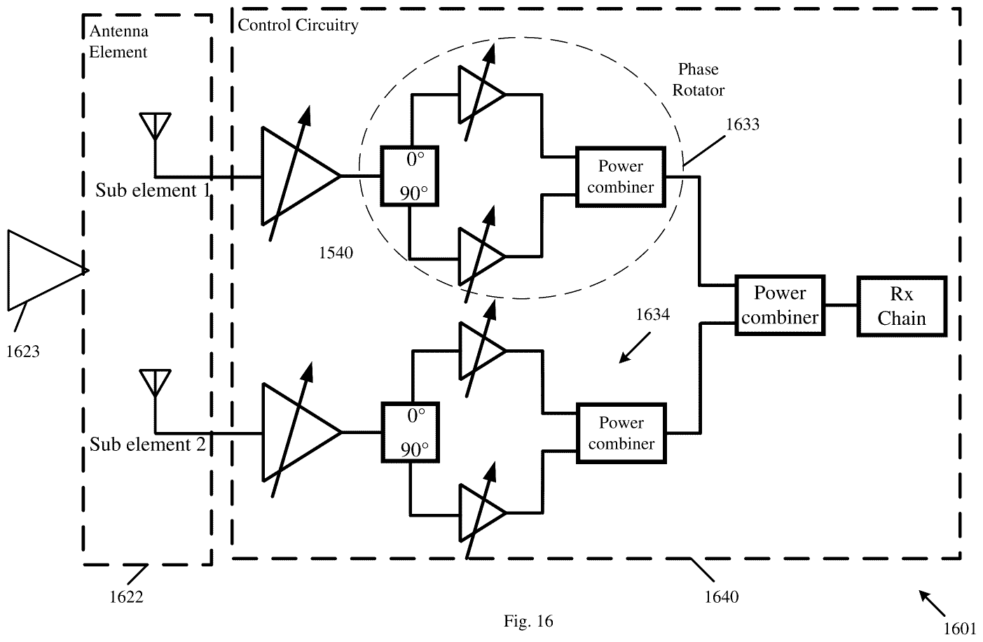

Reference is made to FIG. 16, which schematically illustrates Rx circuitry 1601 including Rx control circuitry 1640, in accordance with some demonstrative aspects.

For example, control circuitry 1040 (FIG. 10) may include one or more elements of Rx control circuitry 1640, and/or may perform one or more operations and/or functionalities of Rx control circuitry 1640.

In some demonstrative aspects, Rx control circuitry 1640 may be configured to control a configurable element-radiation-pattern 1623 of a configurable-radiation-pattern antenna element 1622, for example, according to an element-radiation-pattern setting for the configurable-radiation-pattern antenna element 1622.

For example, configurable-radiation-pattern antenna element 1022 (FIG. 10) may include one or more elements of configurable-radiation-pattern antenna element 1622, and/or may perform one or more operations and/or functionalities of configurable-radiation-pattern antenna element 1622.

In some demonstrative aspects, as shown in FIG. 16, Rx control circuitry 1640 may have a configuration similar to Rx control circuitry 1540 (FIG. 15), for example, while including a first phase rotator 1633, for example, instead of first phase shifter 1533 (FIG. 15), and a second phase rotator 1634, for example, instead of second phase shifter 1534 (FIG. 15).

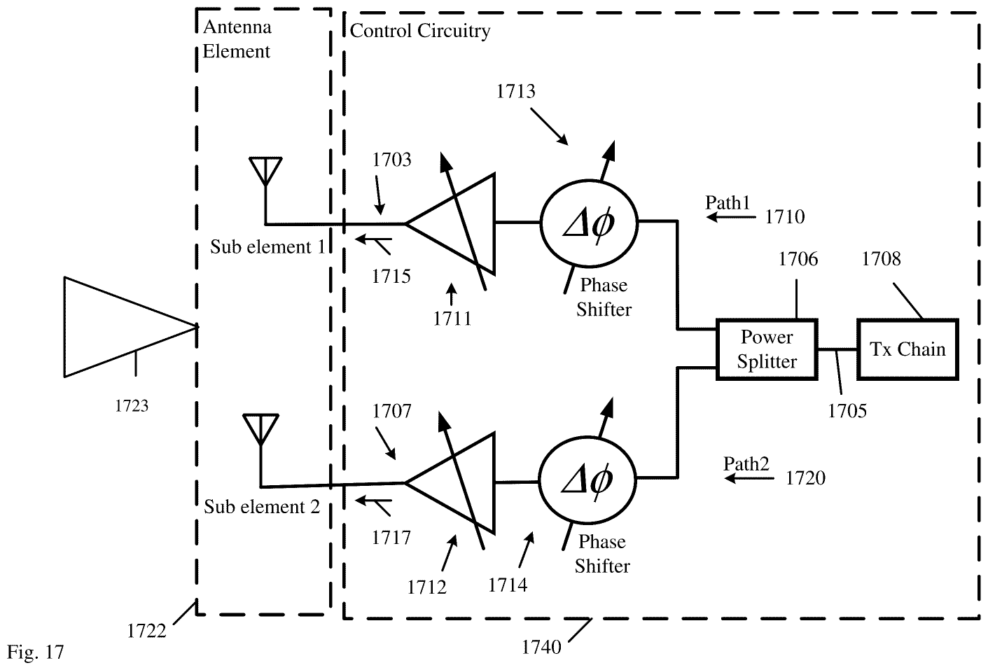

Reference is made to FIG. 17, which schematically illustrates Tx circuitry 1701 including Tx control circuitry 1740, in accordance with some demonstrative aspects.

For example, control circuitry 1040 (FIG. 10) may include one or more elements of Tx control circuitry 1740, and/or may perform one or more operations and/or functionalities of Tx control circuitry 1740.

In some demonstrative aspects, Tx control circuitry 1740 may be configured to control a configurable element-radiation-pattern 1723 of a configurable-radiation-pattern antenna element 1722, for example, according to an element-radiation-pattern setting for the configurable-radiation-pattern antenna element 1722.

In some demonstrative aspects, as shown in FIG. 17, configurable-radiation-pattern antenna element 1722 may include a first sub-antenna element (Sub element 1), and a second sub-antenna element (Sub element 2).

For example, configurable-radiation-pattern antenna element 1022 (FIG. 10) may include one or more elements of configurable-radiation-pattern antenna element 1722, and/or may perform one or more operations and/or functionalities of configurable-radiation-pattern antenna element 1722.

In some demonstrative aspects, as shown in FIG. 17, configurable-radiation-pattern antenna element 1722 may include a first port 1703 connecting the first sub-antenna element to Tx control circuitry 1740.

In some demonstrative aspects, as shown in FIG. 17, configurable-radiation-pattern antenna element 1722 may include a second port 1707 connecting the second sub-antenna element to Tx control circuitry 1740.

In some demonstrative aspects, as shown in FIG. 17, Tx control circuitry 1740 may include a first Tx path 1710, which may be configured to transmit a first Tx signal 1715 via the first antenna port 1703.

In some demonstrative aspects, as shown in FIG. 17, Tx control circuitry 1740 may include a second Tx path 1720, which may be configured to transmit a second Tx signal 1717 via the second antenna port 1707.

In some demonstrative aspects, as shown in FIG. 17, first Tx path 1710 may include a first PA 1711, which may be configured to amplify the first Tx signal 1715.

In some demonstrative aspects, as shown in FIG. 17, first Tx path 1710 may include a first phase shifter 1713, which may be configured to apply a first phase shift to the first Tx signal 1715.

In some demonstrative aspects, as shown in FIG. 17, second Tx path 1720 may include a second PA 1712, which may be configured to amplify the second Tx signal 1717.

In some demonstrative aspects, as shown in FIG. 17, second Tx path 1720 may include a second phase shifter 1714, which may be configured to apply a second phase shift to the second Tx signal 1717.

In some demonstrative aspects, as shown in FIG. 17, Tx control circuitry 1740 may include a power splitter 1706, which may be configured to split a Tx signal 1705 into the first Tx signal 1715 and the second Tx signal 1715.

In some demonstrative aspects, as shown in FIG. 17, Tx control circuitry 1740 may include Tx chain circuitry 1708, which may be configured to generate the Tx signal 1705.

In some demonstrative aspects, Tx control circuitry 1740 may be configured to control a gain of PA 1711 and/or a gain of PA 1712, for example, based on the element-radiation-pattern setting for the configurable-radiation-pattern antenna element 1722.

In some demonstrative aspects, Tx control circuitry 1740 may be configured to control phase shifter 1713 and/or phase shifter 1714, for example, to apply a phase offset between the first Tx signal 1715 in the first Tx path 1710 and the second Tx signal 1717 in the second Tx path 1720, for example, based on the element-radiation-pattern setting for the configurable-radiation-pattern antenna element 1722.

In some demonstrative aspects, each PA of the PAs of the Tx control circuitry 1740 may have a gain control, and/or each phase shifter of the phase shifters of the Tx control circuitry 1740 may have an offset control feature.

In other aspects, only one PA of the PAs of the Tx control circuitry 1740 may have a gain control, and/or only one phase shifter of the phase shifters of the Tx polarization control circuitry 1740 may have an offset control feature. For example, Tx control circuitry 1740 may include a single variable phase shifter, and/or a single gain-controlled PA.

In some demonstrative aspects, as shown in FIG. 17, Tx control circuitry 1740 may include two Tx paths, which may be connected to two sub-antenna elements of the configurable-radiation-pattern antenna element 1722 via two ports of the configurable-radiation-pattern antenna element 1722.

In other aspects, Tx control circuitry 1740 may include more than two Tx paths, which may be connected to more than two sub-antenna elements of the configurable-radiation-pattern antenna element 1722 via more than two ports of the configurable-radiation-pattern antenna element 1722.

In some demonstrative aspects, Tx control circuitry 1740 may include at least one phase rotator, for example, instead of at least one phase shifter, e.g., phase shifter 1713 and/or phase shifter 1714, for example, to provide a technical solution to support phase offsets with an improved resolution.

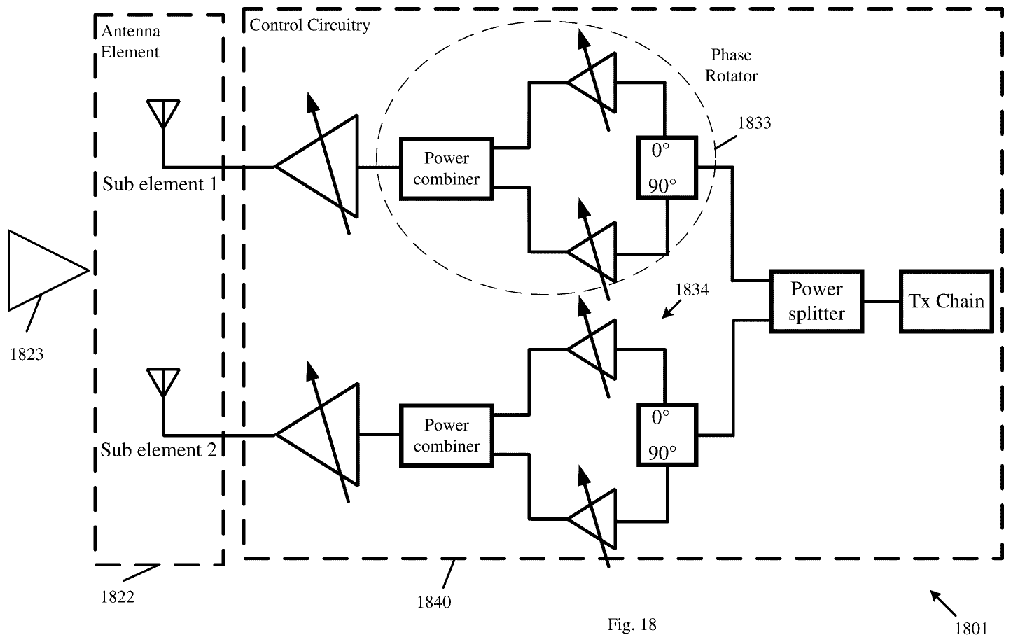

Reference is made to FIG. 18, which schematically illustrates Tx circuitry 1801 including Tx control circuitry 1840, in accordance with some demonstrative aspects.

For example, control circuitry 1040 (FIG. 10) may include one or more elements of Tx control circuitry 1840, and/or may perform one or more operations and/or functionalities of Tx control circuitry 1840.

In some demonstrative aspects, Tx control circuitry 1840 may be configured to control a configurable element-radiation-pattern 1823 of a configurable-radiation-pattern antenna element 1822, for example, according to an element-radiation-pattern setting for the configurable-radiation-pattern antenna element 1822.

For example, configurable-radiation-pattern antenna element 1022 (FIG. 10) may include one or more elements of configurable-radiation-pattern antenna element 1822, and/or may perform one or more operations and/or functionalities of configurable-radiation-pattern antenna element 1822.

In some demonstrative aspects, as shown in FIG. 18, Tx control circuitry 1840 may have a configuration similar to Tx control circuitry 1740 (FIG. 17), for example, while including a first phase rotator 1833, for example, instead of first phase shifter 1713 (FIG. 17), and a second phase rotator 1834, for example, instead of second phase shifter 1714 (FIG. 17).

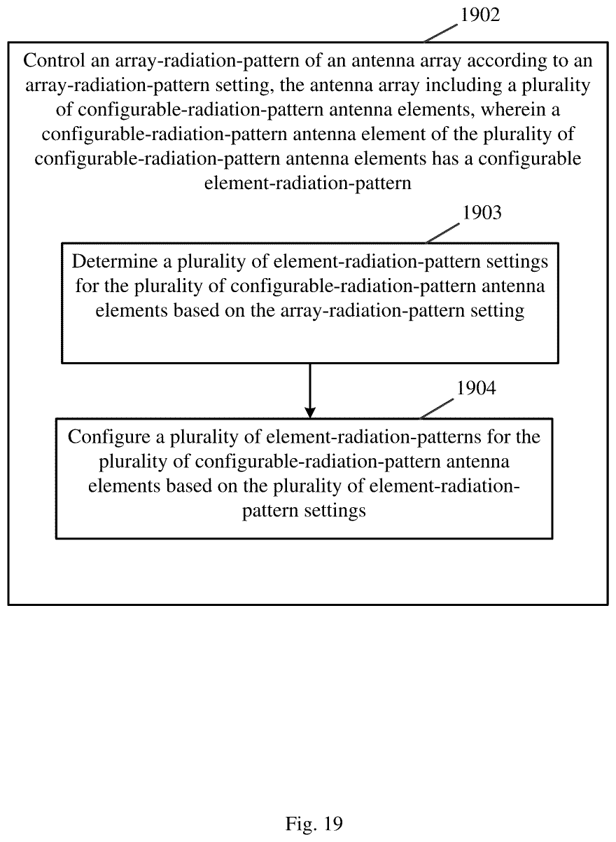

Reference is made to FIG. 19, which schematically illustrates a method of controlling an array-radiation-pattern of the antenna array, in accordance with some demonstrative aspects. For example, one or more of the operations of the method of FIG. 19 may be performed by a radar system, e.g., radar system 900 (FIG. 9); a radar device, e.g., radar device 800 (FIG. 8); a radar front-end, e.g., radar front-end 804 (FIG. 8); and/or control circuitry, e.g., control circuitry 1040 (FIG. 10).

As indicated at block 1902, the method may include controlling an array-radiation-pattern of an antenna array according to an array-radiation-pattern setting. For example, the antenna array may include a plurality of configurable-radiation-pattern antenna elements. For example, a configurable-radiation-pattern antenna element of the plurality of configurable-radiation-pattern antenna elements may have a configurable element-radiation-pattern. For example, control circuitry 1040 (FIG. 10) may be configured to control the array-radiation-pattern 1024 (FIG. 10) of the antenna array 1020 (FIG. 10), for example, according to the array-radiation-pattern setting, e.g., as described above.

As indicated at block 1903, the method may include determining a plurality of element-radiation-pattern settings for the plurality of configurable-radiation-pattern antenna elements based on the array-radiation-pattern setting. For example, control circuitry 1040 (FIG. 10) may be configured to determine the plurality of element-radiation-pattern settings for the plurality of configurable-radiation-pattern antenna elements 1022 (FIG. 10), for example, based on the array-radiation-pattern setting for the antenna array 1020 (FIG. 10), e.g., as described above.

As indicated at block 1904, the method may include configuring a plurality of element-radiation-patterns for the plurality of configurable-radiation-pattern antenna elements based on the plurality of element-radiation-pattern settings. For example, control circuitry 1040 (FIG. 10) may be configured to configure the plurality of element-radiation-patterns 1023 (FIG. 10) for the plurality of configurable-radiation-pattern antenna elements 1022 (FIG. 10), for example, based on the plurality of element-radiation-pattern settings, e.g., as described above.

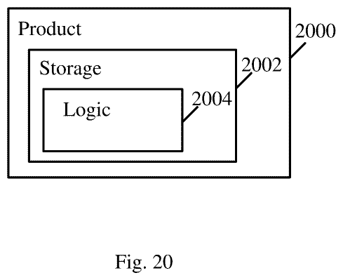

Reference is made to FIG. 20, which schematically illustrates a product of manufacture 2000, in accordance with some demonstrative aspects. Product 2000 may include one or more tangible computer-readable (“machine-readable”) non-transitory storage media 2002, which may include computer-executable instructions, e.g., implemented by logic 2004, operable to, when executed by at least one computer processor, enable the at least one computer processor to implement one or more operations and/or functionalities described with reference to any of the FIGS. 1-19, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 2000 and/or machine-readable storage media 2002 may include one or more types of computer-readable storage media capable of storing data, including volatile memory, non-volatile memory, removable or non-removable memory, erasable or non-erasable memory, writeable or re-writeable memory, and the like. For example, machine-readable storage media 2002 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 2004 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 2004 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an apparatus comprising an antenna array comprising a plurality of configurable-radiation-pattern antenna elements, wherein a configurable-radiation-pattern antenna element of the plurality of configurable-radiation-pattern antenna elements has a configurable element-radiation-pattern; and control circuitry configured to control an array-radiation-pattern of the antenna array according to an array-radiation-pattern setting by configuring a plurality of element-radiation-patterns for the plurality of configurable-radiation-pattern antenna elements based on the array-radiation-pattern setting.

Example 2 includes the subject matter of Example 1, and optionally, wherein the configurable-radiation-pattern antenna element comprises a plurality of sub-antenna elements, wherein the control circuitry is configured to control the configurable element-radiation-pattern of the configurable-radiation-pattern antenna element according to an element-radiation-pattern setting for the configurable-radiation-pattern antenna element by configuring a sub-element setting for the plurality of sub-antenna elements based on the element-radiation-pattern setting for the configurable-radiation-pattern antenna element.

Example 3 includes the subject matter of Example 2, and optionally, wherein the sub-element setting for the plurality of sub-antenna elements comprises a setting for Radio Frequency (RF) signals to be communicated via the plurality of sub-antenna elements.

Example 4 includes the subject matter of Example 2 or 3, and optionally, wherein the sub-element setting for the plurality of sub-antenna elements comprises a phase setting for the plurality of sub-antenna elements, the phase setting comprising phases to be applied between Radio Frequency (RF) signals communicated via the plurality of sub-antenna elements.

Example 5 includes the subject matter of Example 4, and optionally, wherein the control circuitry is configured to control a first phase setting for the plurality of sub-antenna elements, the first phase setting comprising first phases to be applied between the RF signals communicated via the plurality of sub-antenna elements, wherein the control circuitry is configured to control a second phase setting for the plurality of sub-antenna elements, the second phase setting comprising second phases to be applied between the RF signals communicated via the plurality of sub-antenna elements, wherein the second phase setting is different from the first phase setting.

Example 6 includes the subject matter of Example 5, and optionally, wherein the control circuitry is configured to configure the first phase setting based on a first steering angle corresponding to a first element-radiation-pattern setting for the configurable-radiation-pattern antenna element, and to configure the second phase setting based on a second steering angle corresponding to a second element-radiation-pattern setting for the configurable-radiation-pattern antenna element, the second steering angle is different from the first steering angle.

Example 7 includes the subject matter of any one of Examples 2-6, and optionally, wherein the sub-element setting for the plurality of sub-antenna elements comprises a sub-element count setting, the sub-element count setting comprising a count of active sub-antenna elements of the plurality of sub-antenna elements to communicate RF signals.

Example 8 includes the subject matter of Example 7, and optionally, wherein the control circuitry is configured to control a first sub-element count setting comprising a first count of active sub-antenna elements based on a first element-radiation-pattern setting, and to control a second sub-element count setting comprising a second count of active sub-antenna elements based on a second element-radiation-pattern setting different from the first element-radiation-pattern setting, wherein the second count of active sub-antenna elements is different from the first count of active sub-antenna elements.

Example 9 includes the subject matter of Example 8, and optionally, wherein the control circuitry is configured to configure the first sub-element count setting based on a first beam-width corresponding to a first element-radiation-pattern setting for the configurable-radiation-pattern antenna element, wherein the control circuitry is configured to configure the second sub-element count setting based on a second beam-width corresponding to a second element-radiation-pattern setting for the configurable-radiation-pattern antenna element, the second beam-width is different from the first beam-width.

Example 10 includes the subject matter of Example 9, and optionally, wherein the first beam-width is wider than the second beam-width, wherein the first count of active sub-antenna elements is less than the second count of active sub-antenna elements.

Example 11 includes the subject matter of any one of Examples 8-10, and optionally, wherein the control circuitry is configured to configure the first sub-element count setting based on a first beam-gain corresponding to a first element-radiation-pattern setting for the configurable-radiation-pattern antenna element, wherein the control circuitry is configured to configure the second sub-element count setting based on a second beam-gain corresponding to a second element-radiation-pattern setting for the configurable-radiation-pattern antenna element, the second beam-gain is different from the first beam-gain.

Example 12 includes the subject matter of Example 11, and optionally, wherein the second beam-gain is greater than the first beam-gain, wherein the second count of active sub-antenna elements is greater than the first count of active sub-antenna elements.

Example 13 includes the subject matter of any one of Examples 8-12, and optionally, wherein the first count of active sub-antenna elements is one.

Example 14 includes the subject matter of any one of Examples 8-13, and optionally, wherein the second count of active sub-antenna elements is greater than one.

Example 15 includes the subject matter of any one of Examples 2-14, and optionally, wherein the sub-element setting for the plurality of sub-antenna elements comprises a sub-element gain setting for the plurality of sub-antenna elements, the sub-element gain setting comprising a plurality of gains to be applied to Radio Frequency (RF) signals communicated via the plurality of sub-antenna elements.

Example 16 includes the subject matter of Example 15, and optionally, wherein the plurality of gains comprises a first gain to be applied with respect to a first sub-antenna element of the plurality of sub-antenna elements, and a second gain to be applied with respect to a second sub-antenna element of the plurality of sub-antenna elements, wherein the second gain is different from the first gain.

Example 17 includes the subject matter of Example 15 or 16, and optionally, wherein the plurality of gains comprises a first gain to be applied with respect to a first sub-antenna element of the plurality of sub-antenna elements, and a second gain to be applied with respect to a second sub-antenna element of the plurality of sub-antenna elements, wherein the second gain is substantially equal to the first gain.

Example 18 includes the subject matter of Example 17, and optionally, wherein the plurality of gains comprises a third gain to be applied with respect to a third sub-antenna element of the plurality of sub-antenna elements, wherein the third gain is different from the first gain.

Example 19 includes the subject matter of any one of Examples 15-18, and optionally, wherein the control circuitry is configured to control a first sub-element gain setting for the plurality of sub-antenna elements based on a first element-radiation-pattern setting for the configurable-radiation-pattern antenna element, and to control a second sub-element gain setting for the plurality of sub-antenna elements based on a second element-radiation-pattern setting for the configurable-radiation-pattern antenna element, wherein the second element-radiation-pattern setting is different from the first element-radiation-pattern setting, the second sub-element gain setting is different from the first sub-element gain setting.

Example 20 includes the subject matter of any one of Examples 2-19, and optionally, wherein the element-radiation-pattern setting comprises at least one setting of a beam-width setting of a beam-width of the configurable element-radiation-pattern, a beam-gain setting of a beam-gain of the configurable element-radiation-pattern, or a steering angle setting of a steering angle of the configurable element-radiation-pattern.

Example 21 includes the subject matter of any one of Examples 2-20, and optionally, wherein the configurable radiation-pattern antenna element comprises a plurality of ports to connect the plurality of sub-antenna elements to the control circuitry.

Example 22 includes the subject matter of any one of Examples 1-21, and optionally, wherein the control circuitry is configured to configure a first element-radiation-pattern for a first configurable-radiation-pattern antenna element of the plurality of configurable-radiation-pattern antenna elements based on the array-radiation-pattern setting, and to configure a second element-radiation-pattern for a second configurable-radiation-pattern antenna element of the plurality of configurable-radiation-pattern antenna elements based on the array-radiation-pattern setting, wherein the first element-radiation-pattern is different from the second element-radiation-pattern.

Example 23 includes the subject matter of any one of Examples 1-22, and optionally, wherein the control circuitry is configured to configure a same element-radiation-pattern for two or more configurable-radiation-pattern antenna elements of the plurality of configurable-radiation-pattern antenna elements based on the array-radiation-pattern setting.

Example 24 includes the subject matter of any one of Examples 1-23, and optionally, wherein the configurable-radiation-pattern antenna element comprises a multi-patch antenna element, the multi-patch antenna element comprising a first antenna patch; a second antenna patch; a first port connecting the first patch to the control circuitry; a second port connecting the second patch to the control circuitry; wherein the control circuitry is configured control the configurable element-radiation-pattern of the configurable-radiation-pattern antenna element according to an element-radiation-pattern setting for the configurable-radiation-pattern antenna element by configuring a setting for the first antenna patch and the second antenna patch based on the element-radiation-pattern setting for the configurable-radiation-pattern antenna element.

Example 25 includes the subject matter of Example 24, and optionally, wherein a width of each of the first antenna patch and the second antenna path is no more than a quarter of a wavelength of a Radio Frequency (RF) signal to be communicated via the configurable-radiation-pattern antenna element.

Example 26 includes the subject matter of Example 24 or 25, and optionally, wherein the first port is on a first side of the configurable-radiation-pattern antenna element, and the second port is on a second side of the configurable-radiation-pattern antenna element opposite to the first side.

Example 27 includes the subject matter of any one of Examples 24-26, and optionally, wherein the configurable-radiation-pattern antenna element comprises a plurality of grounded vias between the first antenna patch and the second antenna patch.

Example 28 includes the subject matter of any one of Examples 24-27, and optionally, wherein the first antenna patch comprises a first quarter wavelength patch, and the second antenna patch comprises a second quarter wavelength patch, wherein the first quarter wavelength patch and the second quarter wavelength patch share a same plurality of ground vias.

Example 29 includes the subject matter of any one of Examples 1-28, and optionally, wherein the configurable-radiation-pattern antenna element comprises a plurality of ports, wherein the control circuitry comprises a plurality of Radio Frequency (RF) paths connected to the plurality of ports, the plurality of RF paths configured to process RF signals to be communicated via the plurality of ports.

Example 30 includes the subject matter of Example 29, and optionally, wherein at least one RF path of the plurality of RF paths comprises at least one amplifier, wherein the control circuitry is configured to control a gain of the amplifier based on an element-radiation-pattern setting for the configurable-radiation-pattern antenna element.

Example 31 includes the subject matter of Example 29 or 30, and optionally, wherein at least one RF path of the plurality of RF paths comprises at least one phase shifter, wherein the control circuitry is configured to set a phase shift to be applied by the phase shifter to an RF signal via the at least one RF path.

Example 32 includes the subject matter of any one of Examples 1-31, and optionally, wherein the control circuitry is configured to configure a first plurality of element-radiation-patterns for the plurality of configurable-radiation-pattern antenna elements based on a first array-radiation-pattern setting, and to configure a second plurality of element-radiation-patterns for the plurality of configurable-radiation-pattern antenna elements based on a second array-radiation-pattern setting, wherein the second array-radiation-pattern setting is different from the first array-radiation-pattern setting, the second plurality of element-radiation-patterns is different from the first plurality of element-radiation-patterns.

Example 33 includes the subject matter of any one of Examples 1-32, and optionally, wherein the control circuitry is configured to control a width of the configurable element-radiation-pattern of the configurable-radiation-pattern antenna element based on the array-radiation-pattern setting.

Example 34 includes the subject matter of any one of Examples 1-33, and optionally, wherein the control circuitry is configured to control a steering angle of the configurable element-radiation-pattern of the configurable-radiation-pattern antenna element based on the array-radiation-pattern setting.

Example 35 includes the subject matter of any one of Examples 1-34, and optionally, wherein a width of the configurable-radiation-pattern antenna element is no more than half of a wavelength of a Radio Frequency (RF) signal to be communicated via the configurable-radiation-pattern antenna element.

Example 36 includes the subject matter of any one of Examples 1-35, and optionally, wherein the array-radiation-pattern setting comprises at least one setting of a width setting of a width of the array-radiation-pattern, or a steering angle setting of a steering angle of the array-radiation-pattern.

Example 37 includes the subject matter of any one of Examples 1-36, and optionally, wherein the control circuitry is to configure the plurality of element-radiation-patterns for the plurality of configurable-radiation-pattern antenna elements such that the array-radiation-pattern of the antenna array is to be formed by a combination of the plurality of element-radiation-patterns.

Example 38 includes the subject matter of any one of Examples 1-37, and optionally, comprising a radar device, the radar device comprising a Transmit (Tx) array comprising a plurality of Tx antennas connected to a plurality of Tx chains to transmit radar Tx signals, and a receive (Rx) array comprising a plurality of Rx antennas connected to a plurality of Rx chains to receive radar Rx signals based on the radar Tx signals, wherein at least one of the Tx array or the Rx array comprises the antenna array.

Example 39 includes the subject matter of Example 38, and optionally, comprising a radar processor configured to generate radar information based on the Radar Rx signals.

Example 40 includes the subject matter of Example 39, and optionally, comprising a vehicle, the vehicle comprising the radar device, and a system controller to control one or more systems of the vehicle based on the radar information.

Example 41 includes a device comprising the apparatus of any of Examples 1-40 and a communication interface to communicate signals via the antenna array.

Example 42 includes a controller configured to control an array-radiation pattern of an antenna array according to any of Examples 1-40.

Example 43 includes an antenna array comprising a plurality of configurable-radiation-pattern antenna elements according to any of Examples 1-40.

Example 44 includes a device comprising an antenna array, a communication interface to communicate signals via the antenna array, and a controller configured to control an array-radiation pattern of the antenna array according to any of Examples 1-40.

Example 45 comprises a product comprising one or more tangible computer-readable non-transitory storage media comprising instructions operable to, when executed by at least one processor, enable the at least one processor to cause a device to perform any of the described operations of any of Examples 1-40.

Example 46 includes a method of controlling an array-radiation pattern of an antenna array according to any of Examples 1-40.

Example 47 includes an apparatus comprising means for controlling an array-radiation pattern of an antenna array according to any of Examples 1-40.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising:
an antenna array comprising a plurality of configurable-radiation-pattern antenna elements, wherein a configurable-radiation-pattern antenna element of the plurality of configurable-radiation-pattern antenna elements has a configurable element-radiation-pattern; and
control circuitry configured to control an array-radiation-pattern of the antenna array according to an array-radiation-pattern setting by configuring a plurality of element-radiation-patterns for the plurality of configurable-radiation-pattern antenna elements based on the array-radiation-pattern setting.

2. The apparatus of claim 1, wherein the configurable-radiation-pattern antenna element comprises a plurality of sub-antenna elements, wherein the control circuitry is configured to control the configurable element-radiation-pattern of the configurable-radiation-pattern antenna element according to an element-radiation-pattern setting for the configurable-radiation-pattern antenna element by configuring a sub-element setting for the plurality of sub-antenna elements based on the element-radiation-pattern setting for the configurable-radiation-pattern antenna element.

3. The apparatus of claim 2, wherein the sub-element setting for the plurality of sub-antenna elements comprises a setting for Radio Frequency (RF) signals to be communicated via the plurality of sub-antenna elements.

4. The apparatus of claim 2, wherein the sub-element setting for the plurality of sub-antenna elements comprises a phase setting for the plurality of sub-antenna elements, the phase setting comprising phases to be applied between Radio Frequency (RF) signals communicated via the plurality of sub-antenna elements.

5. The apparatus of claim 4, wherein the control circuitry is configured to control a first phase setting for the plurality of sub-antenna elements, the first phase setting comprising first phases to be applied between the RF signals communicated via the plurality of sub-antenna elements, wherein the control circuitry is configured to control a second phase setting for the plurality of sub-antenna elements, the second phase setting comprising second phases to be applied between the RF signals communicated via the plurality of sub-antenna elements, wherein the second phase setting is different from the first phase setting, wherein the control circuitry is configured to configure the first phase setting based on a first steering angle corresponding to a first element-radiation-pattern setting for the configurable-radiation-pattern antenna element, and to configure the second phase setting based on a second steering angle corresponding to a second element-radiation-pattern setting for the configurable-radiation-pattern antenna element, the second steering angle is different from the first steering angle.

6. The apparatus of claim 2, wherein the sub-element setting for the plurality of sub-antenna elements comprises a sub-element count setting, the sub-element count setting comprising a count of active sub-antenna elements of the plurality of sub-antenna elements to communicate RF signals.

7. The apparatus of claim 6, wherein the control circuitry is configured to control a first sub-element count setting comprising a first count of active sub-antenna elements based on a first element-radiation-pattern setting, and to control a second sub-element count setting comprising a second count of active sub-antenna elements based on a second element-radiation-pattern setting different from the first element-radiation-pattern setting, wherein the second count of active sub-antenna elements is different from the first count of active sub-antenna elements.

8. The apparatus of claim 2, wherein the sub-element setting for the plurality of sub-antenna elements comprises a sub-element gain setting for the plurality of sub-antenna elements, the sub-element gain setting comprising a plurality of gains to be applied to Radio Frequency (RF) signals communicated via the plurality of sub-antenna elements.

9. The apparatus of claim 8, wherein the plurality of gains comprises a first gain to be applied with respect to a first sub-antenna element of the plurality of sub-antenna elements, and a second gain to be applied with respect to a second sub-antenna element of the plurality of sub-antenna elements, wherein the second gain is different from the first gain.

10. The apparatus of claim 2, wherein the element-radiation-pattern setting comprises at least one setting of a beam-width setting of a beam-width of the configurable element-radiation-pattern, a beam-gain setting of a beam-gain of the configurable element-radiation-pattern, or a steering angle setting of a steering angle of the configurable element-radiation-pattern.

11. The apparatus of claim 1, wherein the control circuitry is configured to configure a first element-radiation-pattern for a first configurable-radiation-pattern antenna element of the plurality of configurable-radiation-pattern antenna elements based on the array-radiation-pattern setting, and to configure a second element-radiation-pattern for a second configurable-radiation-pattern antenna element of the plurality of configurable-radiation-pattern antenna elements based on the array-radiation-pattern setting, wherein the first element-radiation-pattern is different from the second element-radiation-pattern.

12. The apparatus of claim 1, wherein the configurable-radiation-pattern antenna element comprises a multi-patch antenna element, the multi-patch antenna element comprising:
a first antenna patch;
a second antenna patch;
a first port connecting the first patch to the control circuitry; and
a second port connecting the second patch to the control circuitry;
wherein the control circuitry is configured control the configurable element-radiation-pattern of the configurable-radiation-pattern antenna element according to an element-radiation-pattern setting for the configurable-radiation-pattern antenna element by configuring a setting for the first antenna patch and the second antenna patch based on the element-radiation-pattern setting for the configurable-radiation-pattern antenna element.

13. The apparatus of claim 12, wherein a width of each of the first antenna patch and the second antenna path is no more than a quarter of a wavelength of a Radio Frequency (RF) signal to be communicated via the configurable-radiation-pattern antenna element.

14. The apparatus of claim 12, wherein the first port is on a first side of the configurable-radiation-pattern antenna element, and the second port is on a second side of the configurable-radiation-pattern antenna element opposite to the first side.

15. The apparatus of claim 12, wherein the configurable-radiation-pattern antenna element comprises a plurality of grounded vias between the first antenna patch and the second antenna patch.

16. The apparatus of claim 12, wherein the first antenna patch comprises a first quarter wavelength patch, and the second antenna patch comprises a second quarter wavelength patch, wherein the first quarter wavelength patch and the second quarter wavelength patch share a same plurality of ground vias.

17. The apparatus of claim 1, wherein the configurable-radiation-pattern antenna element comprises a plurality of ports, wherein the control circuitry comprises a plurality of Radio Frequency (RF) paths connected to the plurality of ports, the plurality of RF paths configured to process RF signals to be communicated via the plurality of ports.

18. The apparatus of claim 17, wherein at least one RF path of the plurality of RF paths comprises at least one amplifier, wherein the control circuitry is configured to control a gain of the amplifier based on an element-radiation-pattern setting for the configurable-radiation-pattern antenna element.

19. The apparatus of claim 17, wherein at least one RF path of the plurality of RF paths comprises at least one phase shifter, wherein the control circuitry is configured to set a phase shift to be applied by the phase shifter to an RF signal via the at least one RF path.

20. The apparatus of claim 1, wherein the control circuitry is configured to control a width of the configurable element-radiation-pattern of the configurable-radiation-pattern antenna element based on the array-radiation-pattern setting.

21. The apparatus of claim 1, wherein the control circuitry is configured to control a steering angle of the configurable element-radiation-pattern of the configurable-radiation-pattern antenna element based on the array-radiation-pattern setting.

22. The apparatus of claim 1, wherein a width of the configurable-radiation-pattern antenna element is no more than half of a wavelength of a Radio Frequency (RF) signal to be communicated via the configurable-radiation-pattern antenna element.

23. The apparatus of claim 1, wherein the array-radiation-pattern setting comprises at least one setting of a width setting of a width of the array-radiation-pattern, or a steering angle setting of a steering angle of the array-radiation-pattern.

24. The apparatus of claim 1, wherein the control circuitry is to configure the plurality of element-radiation-patterns for the plurality of configurable-radiation-pattern antenna elements such that the array-radiation-pattern of the antenna array is to be formed by a combination of the plurality of element-radiation-patterns.

25. A radar device comprising:
a Transmit (Tx) array comprising a plurality of Tx antennas to transmit radar Tx signals, and a receive (Rx) array comprising a plurality of Rx antennas to receive radar Rx signals based on the radar Tx signals, wherein at least one of the Tx array or the Rx array comprises an antenna array comprising a plurality of configurable-radiation-pattern antenna elements, wherein a configurable-radiation-pattern antenna element of the plurality of configurable-radiation-pattern antenna elements has a configurable element-radiation-pattern;
control circuitry configured to control an array-radiation-pattern of the antenna array according to an array-radiation-pattern setting by configuring a plurality of element-radiation-patterns for the plurality of configurable-radiation-pattern antenna elements based on the array-radiation-pattern setting; and
a radar processor configured to generate radar information based on the Radar Rx signals.

26. The radar device of claim 25, wherein the configurable-radiation-pattern antenna element comprises a plurality of sub-antenna elements, wherein the control circuitry is configured to control the configurable element-radiation-pattern of the configurable-radiation-pattern antenna element according to an element-radiation-pattern setting for the configurable-radiation-pattern antenna element by configuring a sub-element setting for the plurality of sub-antenna elements based on the element-radiation-pattern setting for the configurable-radiation-pattern antenna element.
